(19) United States
(12) Patent Application Publication
(10) Pub. No.: US 2025/0104922 A1
(43) Pub. Date: Mar. 27, 2025

(54) MULTILAYER ELECTRONIC COMPONENT AND METHOD FOR MANUFACTURING THE SAME

(71) Applicant: SAMSUNG ELECTRO-MECHANICS CO., LTD., Suwon-si (KR)

(72) Inventors: Jung Wun HWANG, Suwon-si (KR); Chae Dong LEE, Suwon-si (KR); Sun Kyoung PARK, Suwon-si (KR); Ji Hye OH, Suwon-si (KR); Jae Hee KIM, Suwon-si (KR); Sang Hyun PARK, Suwon-si (KR)

(73) Assignee: SAMSUNG ELECTRO-MECHANICS CO., LTD., Suwon-si (KR)

(21) Appl. No.: 18/776,769

(22) Filed: Jul. 18, 2024

(30) Foreign Application Priority Data
Sep. 25, 2023 (KR) 10-2023-0128213
Nov. 27, 2023 (KR) 10-2023-0166963

(51) Int. Cl. H01G 4/30; C04B 35/64; H01G 4/008; H01G 4/012; H01G 4/12

(52) U.S. Cl. CPC H01G 4/30; C04B 35/64; H01G 4/008; H01G 4/012; H01G 4/12

(57) ABSTRACT

A multilayer electronic component according to an example embodiment may include: a body including a plurality of dielectric layers, a first internal electrode, a second internal electrode, and a margin pattern; and an external electrode disposed on the body. The first and second internal electrodes may be alternately disposed in a first direction with the dielectric layer interposed therebetween, and the margin pattern may be disposed in a position different from the first and second internal electrodes in the first direction and may be disposed so as not to overlap the first internal electrode or the second internal electrode in the first direction.

### CROSS-REFERENCE TO RELATED APPLICATION(S)

This application claims benefit of priority to Korean Patent Application Nos. 10-2023-0128213 and 10-2023-0166963 filed on Sep. 25, 2023, and Nov. 27, 2023, in the Korean Intellectual Property Office, the disclosures of which are incorporated herein by reference in their entirety.

### TECHNICAL FIELD

The present disclosure relates to a multilayer electronic component and a method for manufacturing the same.

A multilayer ceramic capacitor (MLCC), a multilayer electronic component, is a chip-type condenser mounted on the printed circuit boards of various types of electronic product, such as image display devices including a liquid crystal display (LCD) and a plasma display panel (PDP), computers, smartphones and mobile phones, and circuits such as an On Board Charger (OBC) DC-DC converter of an electric vehicle, and serves to charge or discharge electricity therein or therefrom.

The multilayer ceramic capacitor may be used as a component in various electronic devices due to having a small size, ensuring high capacitance and being easily mounted, and with the miniaturization and high output power of various electronic devices such as computers and mobile devices, demand for miniaturization and high capacitance of multilayer ceramic capacitors has also been increasing.

In accordance with the trend for miniaturization and high capacitance of multilayer ceramic capacitors, the importance of increasing the capacitance per unit volume of multilayer ceramic capacitors is increasing. As a method to achieve miniaturization and high capacitance of multilayer ceramic capacitors, attempts have been made to increase the number of stacks by thinning a thickness of an internal electrodes.

Additionally, with an increase in application to automotive electrical components, high reliability in various environments is required. In order to ensure high reliability, it may be decisive to disperse the concentration of an electrical field by improving the connectivity and thickness uniformity of an internal electrode. Additionally, in order to ensure high reliability in various environments, an excellent high-temperature load lifespan is required.

However, when the number of stacks is improved by forming a thinner internal electrode, the internal electrodes may be bent or bunched up due to a height difference portion in a capacitance formation portion and a margin portion of the multilayer ceramic capacitor, which may cause a problem in that the connectivity of the internal electrode may deteriorate. Additionally, when the number of stacks is improved by forming a thin internal electrode, a separation distance between internal electrodes may be reduced, which may cause a decrease in the break down voltage (BDV) of the multilayer ceramic capacitor.

Additionally, a phenomenon of electrical fields being concentrated in an end of the internal electrodes may become worse as the internal electrodes or dielectric layers become thinner, and may become worse when a high voltage is applied. The phenomenon in which the electrical field is concentrated at the end of the internal electrodes may be another cause of reducing the break down voltage (BDV) of the multilayer ceramic capacitor.

### SUMMARY

An aspect of the present disclosure is to provide a multilayer electronic component in which a phenomenon of electrical field being concentrated in an end of an internal electrode is reduced.

An aspect of the present disclosure is to provide a multilayer electronic component in which a step portion between a capacitance formation portion and a margin portion is alleviated.

An aspect of the present disclosure is to provide a multilayer electronic component having improved electrostatic capacitance.

An aspect of the present disclosure is to provide a multilayer electronic component having excellent high temperature load lifespan.

However, the aspects of the present disclosure are not limited to the above-described contents, and may be more easily understood in the process of describing specific embodiments of the present disclosure.

According to an aspect of the present disclosure, a multilayer electronic component may include: a body including a plurality of dielectric layers, a first internal electrode, a second internal electrode, and a margin pattern; and an external electrode disposed on the body. The first and second internal electrodes are alternately disposed in a first direction with the dielectric layer interposed therebetween, and the margin pattern is disposed in a position different from the first and second internal electrodes in the first direction and is disposed so as not to overlap the first internal electrode or the second internal electrode in the first direction.

According to an aspect of the present disclosure, a method for manufacturing a multilayer electronic component may include: a stacking operation of obtaining a stack body in a manner in which a first sheet with a first pattern disposed on a first ceramic sheet and a second sheet with a second pattern disposed on a second ceramic sheet are alternately stacked in a first direction, a third sheet with a third pattern disposed on a third ceramic sheet is disposed between the first sheet and the second sheet, and the third pattern is stacked so as not to overlap the first pattern or the second pattern in the first direction; a sintering operation of obtaining a body by sintering the stack body; and an operation of forming an external electrode on the body.

According to an aspect of the present disclosure, a multilayer electronic component may include: a body including a capacitance formation portion including a plurality of dielectric layers, a first internal electrode, a second internal electrode, and a margin pattern including a portion disclosed in a region outside the capacitance formation portion; and an external electrode disposed on the body. The first and second internal electrodes are alternately disposed in a first direction with the dielectric layer interposed therebetween, and in the first direction, the margin pattern is disposed in a position different from the first and second internal electrodes.

One of the various effects of the present disclosure is to provide a multilayer electronic component in which a phenomenon of electrical field being concentrated in an end of an internal electrode is reduced, by adjusting a position and a shape of a margin pattern.

One of the various effects of the present disclosure is to provide a multilayer electronic component in which a step portion between a capacitance formation portion and a margin portion is alleviated, by adjusting a position and a shape of a margin pattern.

One of the various effects of the present disclosure is to provide a multilayer electronic component having improved electrostatic capacitance.

One of the various effects of the present disclosure is to provide a multilayer electronic component having excellent high temperature load lifespan.

Various and beneficial advantages and effects of the present application are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an example embodiment of the present disclosure;

FIGS. 2A, 2B, 2C, and 2D are plan views schematically illustrating an internal electrode and a margin pattern of a multilayer electronic component according to an example embodiment;

FIG. 3 is a schematic cross-sectional view taken along line I-I′ of FIG. 1;

FIG. 4 is a schematic cross-sectional view of II-II′ of FIG. 1;

FIG. 5 is a schematic cross-sectional view of III-III′ of FIG. 1;

FIG. 6 is a schematic cross-sectional view of IV-IV′ of FIG. 1;

FIG. 7 is a plan view schematically illustrating a state in which an internal electrode is disposed on a ceramic sheet according to an example embodiment;

FIG. 8 is a plan view schematically illustrating a state in which a margin pattern is disposed on a ceramic sheet according to an example embodiment;

FIGS. 9A, 9B, 9C and 9D are plan views schematically illustrating an internal electrode and a margin pattern according to an example embodiment;

FIGS. 10A, 10B, 10C and 10D are plan views schematically illustrating an internal electrode and a margin pattern according to an example embodiment;

FIGS. 11A, 11B, 11C and 11D are plan views schematically illustrating an internal electrode and a margin pattern according to an example embodiment;

FIGS. 12A, 12B, 12C and 12D are plan views schematically illustrating an internal electrode and a margin pattern according to an example embodiment;

FIGS. 13A, 13B, 13C and 13D are plan views schematically illustrating an internal electrode and a margin pattern according to an example embodiment;

FIGS. 14A, 14B, 14C and 14D are plan views schematically illustrating an internal electrode and a margin pattern according to an example embodiment;

FIGS. 15A, 15B, 15C and 15D are plan views schematically illustrating an internal electrode and a margin pattern according to an example embodiment;

FIGS. 16A, 16B, 16C and 16D are plan views schematically illustrating an internal electrode and a margin pattern according to an example embodiment;

FIGS. 17A, 17B, 17C and 17D are plan views schematically illustrating an internal electrode and a margin pattern according to an example embodiment; and

FIGS. 18A, 18B, 18C and 18D are plan views schematically illustrating an internal electrode and a margin pattern according to an example embodiment.

### DETAILED DESCRIPTION

Hereinafter, embodiments of the present disclosure will be described with reference to specific example embodiments and the attached drawings. The embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

In addition, in order to clearly describe the present disclosure in the drawings, the contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a thickness T direction, a second direction may be defined as a length L direction, and a third direction may be defined as a width W direction.

### Multilayer Electronic Component

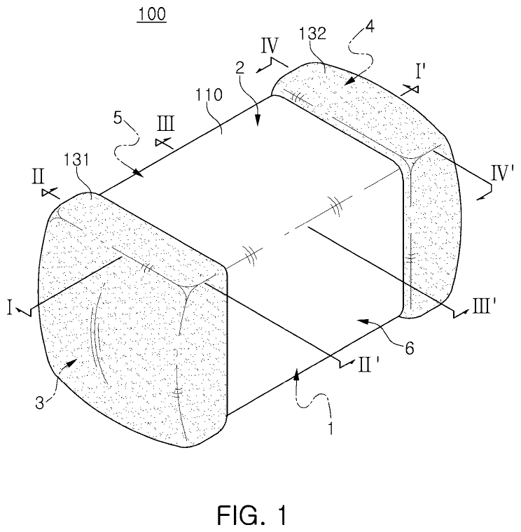

FIG. 1 schematically illustrates a perspective view of a multilayer electronic component according to an example embodiment of the present disclosure.

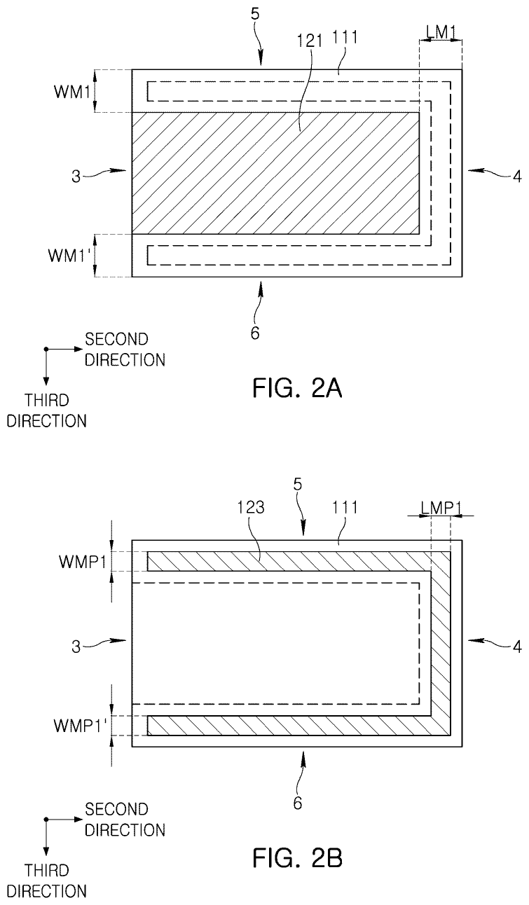

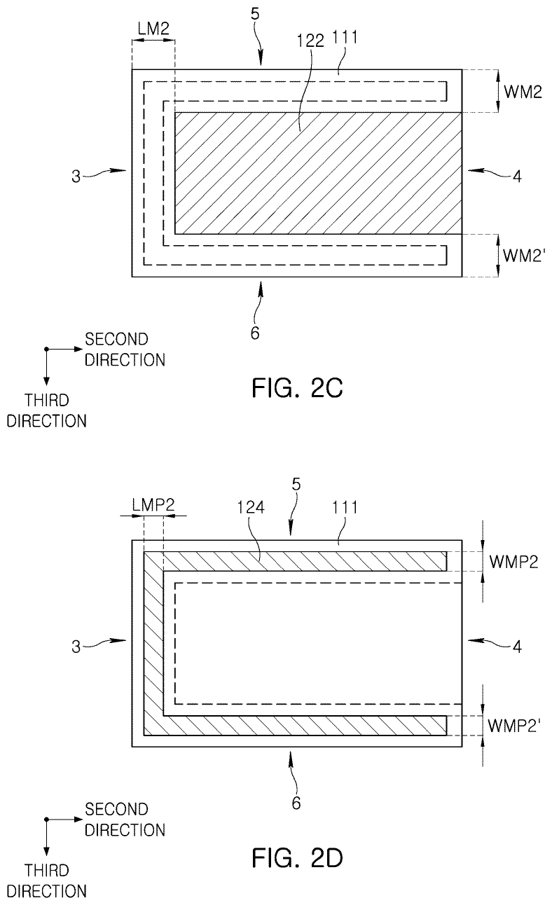

FIGS. 2A, 2B, 2C, and 2D are plan views schematically illustrating an internal electrode and a margin pattern of a multilayer electronic component according to an example embodiment.

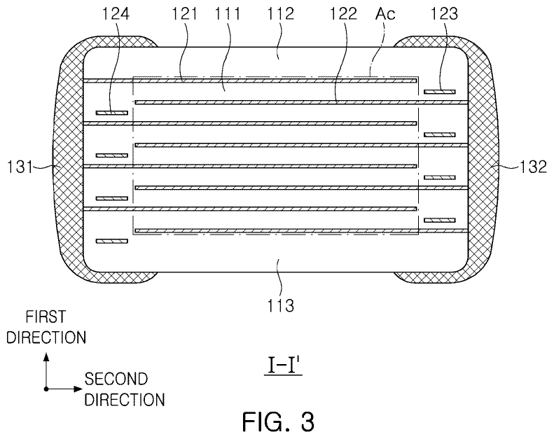

FIG. 3 is a schematic cross-sectional view taken along line I-I′ of FIG. 1.

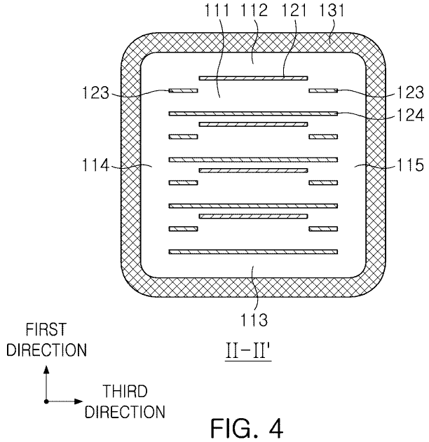

FIG. 4 is a schematic cross-sectional view of II-II′ of FIG. 1.

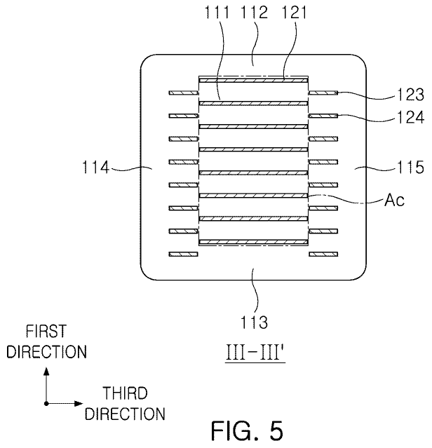

FIG. 5 is a schematic cross-sectional view of III-III′ of FIG. 1.

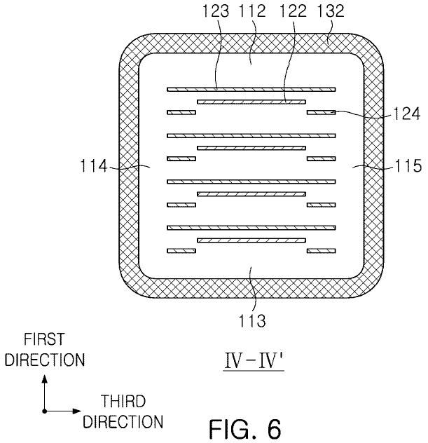

FIG. 6 is a schematic cross-sectional view of IV-IV′ of FIG. 1.

Hereinafter, a multilayer electronic component 100 according to an example embodiment of the present disclosure will be described in detail with reference to FIGS. 1 to 6. Additionally, as an example of a multilayer electronic component, a multilayer ceramic capacitor (hereinafter referred to as ‘MLCC’) will be described, but the present disclosure is not limited thereto, and the multilayer electronic component 100 may also be applied to various multilayer electronic components using ceramic materials, such as an inductor, a piezoelectric element, a varistor, or a thermistor.

The multilayer electronic component 100 according to an example embodiment of the present disclosure may include a body 110 including a plurality of dielectric layers 111, a first internal electrode 121, a second internal electrode 122, and margin patterns 123 and 124, in which the first and second internal electrodes 121 and 122 may be alternately disposed in a first direction with the dielectric layer 111 interposed therebetween, and the margin pattern 123 or 124 is disposed in a different position from the first and second internal electrodes 121 and 122 in the first direction and is disposed so as not to overlap the first internal electrode 121 or the second internal electrode 122 in the first direction; and external electrodes 131 and 132 disposed on the body 110.

A multilayer electronic component 100 according to an example embodiment of the present disclosure may include a plurality of dielectric layers 111, a first internal electrode 121, a second internal electrode 122, and margin patterns 123 and 124, and the first and second internal electrodes 121 and 122 may be alternately disposed in the first direction with the dielectric layer 111 interposed therebetween, and the margin pattern 123 or 124 may be disposed in a different position from the first and second internal electrodes 121 and 122 in the first direction and is disposed so as not to overlap the first internal electrode 121 or the second internal electrode 122 in the first direction, so that a shape in which the electrical field is concentrated in an end of the internal electrode 121 or 122 may be reduced, and a step portion between a capacitance formation portion and a margin portion may be alleviated, thereby improving the electrostatic capacitance and high-temperature load lifespan of the multilayer electronic component.

Hereinafter, each component of the multilayer electronic component 100 will be described in detail.

The body 110 may include a plurality of dielectric layers 111, a first internal electrode 121, a second internal electrode 122, and margin patterns 123 and 124.

There is no particular limitation on a specific shape of the body 110, but as illustrated, the body 110 may have a hexahedral shape or a shape similar thereto. Due to contraction of ceramic powder particles included in the body 110 during a sintering process, the body 110 may not have a hexahedral shape with a complete straight line, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

As margin regions in which the internal electrodes 121 and 122 are not disposed overlap each other on the dielectric layer 111, a step portion due to a thickness of the internal electrodes 121 and 122 may occur, so that a corner connecting the first surface and the third to fifth surfaces and/or a corner connecting the second surface and the third to fifth surfaces may have a shape contracted toward a center of the body 110 in the first direction when viewed from the first surface or the second surface. Alternatively, due to the contraction behavior during the sintering process of the body, a corner connecting the first surface 1 and the third to sixth surfaces 3, 4, 5 and 6 and/or a corner connecting the second surface 2 and the third to sixth surfaces 3, 4, 5 and 6 may have a shape contracted toward a center of the body 110 in the first direction when viewed from the first surface 1 or the second surface 2. Alternatively, in order to prevent chipping defects, the corners connecting each surface of the body 110 may be rounded by performing a separate process, so that the corner connecting the first surface 1 and the third to sixth surfaces 3 to 6 and/or the corner connecting the second surface 2 and the third to sixth surfaces 3 to 6 may have a round shape.

Meanwhile, in order to suppress a height difference portion caused by the internal electrodes 121 and 122, the internal electrodes 121 and 122 after stacking may be cut to expose the fifth and sixth surfaces 5 and 6 of the body, and then, when forming the margin portions 114 and 115 by stacking a single dielectric layer or two or more dielectric layers on both side surfaces of a capacitance formation portion Ac in the third direction (width direction), a portion connecting the first surface 1 to the fifth and sixth surfaces 5 and 6 and a portion connecting the second surface 2 to the fifth and sixth surfaces 5 and 6 may not have a contracted shape.

In a state in which a plurality of dielectric layers 111 forming the body 110 are sintered, boundaries between adjacent dielectric layers 111 may be so integrated so as to be difficult to identify without using a scanning electron microscope (SEM). The number of dielectric layers 111 is not particularly limited, and may be determined in consideration of the size of the multilayer electronic component. For example, the body 110 may be formed by stacking 400 or more dielectric layers 111.

The dielectric layer 111 may be formed by producing a ceramic slurry including ceramic powder particles, an organic solvent and a binder, applying and drying the slurry on a carrier film to prepare a ceramic green sheet, and then firing the ceramic green sheet. The ceramic powder particles are not particularly limited as long as sufficient electrostatic capacitance may be obtained, but for example, barium titanate-based (BaTiO₃)-based powder particles may be used as the ceramic powder particles. For more specific examples, ceramic powder particles may be at least one of BaTiO₃, (Ba₁₋ₓCaₓ) TiO₃ (0<x<1), Ba (Ti_{1-y}Ca_{y})O₃ (0<y<1), (Ba₁₋ₓCaₓ) (Ti_{1-y}Zr_{y})O₃ (0<x<1, 0<y<1), and Ba (Ti_{1-y}Zr_{y}) O₃ (0<y<1).

According to the present disclosure, it may be possible to prevent high temperature load lifespan from being reduced even when a thickness of the dielectric layer 111 is thin, and when the thickness of the dielectric layer 111 is thick, the high temperature load lifespan may be further improved, so that an average thickness td of the dielectric layer 111 is not particularly limited, and the average thickness td of the dielectric layer 111 may be arbitrarily set depending on desired characteristics or purposes. For a specific example, the average thickness of the dielectric layer 111 may be 300 nm or more and 10 μm or less. Additionally, the average thickness of at least one of the plurality of dielectric layers 111 may be 300 nm or more and 10 μm or less.

Here, the average thickness of the dielectric layer 111 may refer to an average size of the dielectric layer 111 disposed between the internal electrodes 121 and 122 in the first direction. The average thickness of the dielectric layer 111 may be measured by scanning first and second directional cross-sections of the body 110 with a scanning electron microscope (SEM) of 10,000× magnification. More specifically, an average value may be measured by measuring the thickness at multiple areas of one dielectric layer 111, for example, 30 areas which are spaced apart from each other at equal intervals in the second direction. The 30 points with the equal intervals may be designated in a capacitance formation portion Ac described below. Additionally, when the average value is measured by extending an average value measurement up to 10 dielectric layers 111, an average size of the dielectric layers 111 may be further generalized.

The internal electrodes 121 and 122 may be alternately disposed with the dielectric layer 111 in the first direction.

The internal electrodes 121 and 122 may include a first internal electrode 121 and a second internal electrode 122. The first and second internal electrodes 121 and 122 may be alternately disposed to face each other with the dielectric layer 111 constituting the body 110 interposed, and may be connected to the third and fourth surfaces 3 and 4 of the body 110, respectively. Specifically, one end of the first internal electrode 121 may be connected to the third surface 3, and one end of the second internal electrode 122 may be connected to the fourth surface 4. That is, in an example embodiment, the internal electrodes 121 and 122 may be in contact with the third surface 3 or the fourth surface 4.

As illustrated in FIGS. 2A to 2D, the first internal electrode 121 may be spaced apart from the fourth surface 4 and may be exposed through the third surface 3, and the second internal electrode 122 may be spaced apart from the third surface 3 and may be exposed through the fourth surface 4. A first external electrode 131 may be disposed on the third surface 3 of the body 110 and may be connected to the first internal electrode 121, and a second external electrode 132 may be disposed on the fourth surface 4 of the body 110 and may be connected to the second internal electrode 122.

That is, the first internal electrode 121 is not connected to the second external electrode 132 but is connected to the first external electrode 131, and the second internal electrode 122 is not connected to the first external electrode 131 but is connected to the second external electrode 132. Accordingly, the first internal electrode 121 may be formed to be spaced apart from the fourth surface 4 by a certain distance, and the second internal electrode 122 may be formed to be spaced apart from the third surface 3 by a certain distance. In this case, the first and second internal electrodes 121 and 122 may be electrically separated from each other by the dielectric layer 111 disposed in the middle thereof.

A material forming the internal electrodes 121 and 122 is not particularly limited, and any material with excellent electrical conductivity can be used. For example, the internal electrodes 121 and 122 may include one or more of nickel (Ni), copper (Cu), palladium (Pd), silver (Ag), gold (Au), platinum (Pt), tin (Sn), and tungsten (W), titanium (Ti), and alloys thereof.

Additionally, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti) and alloys thereof on a ceramic green sheet. A printing method for the conductive paste for internal electrodes may be a screen printing method or a gravure printing method, but the present disclosure is not limited thereto.

An average thickness of the internal electrodes 121 and 122 is not particularly limited and may be arbitrarily set depending on desired characteristics or purposes. For a specific example, the average thickness of the internal electrodes 121 and 122 may be 300 nm or more and 10 μm or less. Additionally, the average thickness of at least one of the plurality of internal electrodes 121 and 122 may be 300 nm or more and 10 μm or less.

In order to obtain the average thickness of the internal electrodes 121 and 122, with respect to a total of five internal electrode layers, two layers on the top and two layers on the bottom based on a first layer of the internal electrode layer at a point in which a longitudinal center line of the body meets a thickness center line in the internal electrode layer extracted from an image obtained by scanning a longitudinal and thickness direction (L-T) cross-section cut at the center of a width direction of the body above 110 with a scanning electron microscope (SEM), an average value may be measured by setting five points, two points to the left and two points to the right based on one reference point as equal intervals and measuring thicknesses at each points, based on a point in which the longitudinal center line meets the thickness direction center line of the body 110.

Referring to FIGS. 3 to 6, the body 110 may include cover portions 112 and 113 formed above and below the capacitance formation portion Ac in the first direction.

Additionally, the capacitance formation portion Ac is a portion contributing to forming the capacitance of a capacitor, and may be formed by repeatedly stacking a plurality of first and second internal electrodes 121 and 122 with the dielectric layer 111 interposed therebetween.

Referring to FIGS. 3 to 6, the cover portions 112 and 113 may include an upper cover portion 112 disposed above the capacitance formation portion Ac in the first direction, and a lower cover portion 113 disposed below the capacitance formation portion Ac in the first direction.

The upper cover portion 112 and the lower cover portion 113 may be formed by stacking a single dielectric layer or two or more dielectric layers in a thickness direction on upper and lower surfaces of the capacitance formation portion Ac, respectively, and may basically serve to prevent damage to the internal electrode due to physical or chemical stress.

The upper cover portion 112 and the lower cover portion 113 do not include internal electrodes and may include the same material as the dielectric layer 111.

That is, the upper cover portion 112 and the lower cover portion 113 may include a ceramic material, for example, a barium titanate (BaTiO₃)-based ceramic material.

Meanwhile, a thickness of the cover portions 112 and 113 does not need to be particularly limited. For example, the thickness of the cover portions 112 and 113 may be 10 to 300 μm. However, in order to more easily achieve miniaturization and high capacitance of the multilayer electronic component, the thickness of the cover portions 112 and 113 may be 15 μm or less.

An average thickness of the cover portions 112 and 113 may refer to a first directional size, and is a value obtained by averaging first directional sizes of the cover portions 112 and 113 measured at five points spaced apart from each other by an equal interval in an upper portion or a lower portion of the capacitance formation portion Ac.

Referring to FIGS. 4 to 6, margin portions 114 and 115 may be disposed on a side surface of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the ceramic body 110 in a width direction.

As illustrated in FIG. 5, the margin portions 114 and 115 may refer to regions between both ends of the first and second internal electrodes 121 and 122 and a boundary surface of the body 110 in a cross-section obtained by cutting the body 110 in a width-thickness (W-T) direction.

The margin portions 114 and 115 may basically serve to prevent damage to the internal electrodes due to physical or chemical stress.

The margin portions 114 and 115 may be formed by forming internal electrodes by applying a conductive paste on a ceramic green sheet except for regions in which the margin portion is to be formed.

Additionally, in order to suppress a step portion caused by the internal electrodes 121 and 122, the internal electrodes 121 and 122 after stacking may be cut to expose the fifth and sixth surfaces 5 and 6 of the body, and then, the margin portions 114 and 115 may be formed by stacking a single dielectric layer or two or more dielectric layers on both side surfaces of the capacitance formation portion Ac in the third direction (width direction).

Meanwhile, a width of the margin portions 114 and 115 does not need to be particularly limited. For example, the width of the margin portions 114 and 115 may be 5 to 300 μm. However, in order to more easily achieve miniaturization and high capacitance of the multilayer electronic component, an average width of the margin portions 114 and 115 may be 15 μm or less.

The average width of the margin portions 114 and 115 may refer to an average size of a region in which the internal electrode is spaced from the fifth surface, in the third direction, and an average size of a region in which the internal electrode is spaced from the sixth surface, in the third direction, and may be an average value obtained by averaging third directional sizes of the margin portions 114 and 115 measured at five points spaced apart from each other by an equal interval on the side surface of the capacitance formation portion Ac.

Accordingly, in an example embodiment, each of the average sizes of the regions in which the internal electrodes 121 and 122 are spaced apart from the fifth and sixth surfaces 5 and 6 in the third direction may be 15 μm or less.

The external electrodes 131 and 132 may be disposed on the third surface 3 and the fourth surface 4 of the body 110.

The external electrodes 131 and 132 may include first and second external electrodes 131 and 132 disposed on the third and fourth surfaces 3 and 4 of the body 110, respectively, and connected to the first and second internal electrodes 121 and 122, respectively.

In this example embodiment, a structure in which the multilayer electronic component 100 has two external electrodes 131 and 132 is described, but the number or shape of the external electrodes 131 and 132 may be changed depending on the shape of the internal electrodes 121 and 122 or other purposes.

Meanwhile, the external electrodes 131 and 132 may be formed using any material as long as they have electrical conductivity, like a metal, and a specific material may be determined in consideration of electrical properties, structural stability, and the like, and further, the external electrodes 131 and 132 may have a multilayer structure.

For example, the external electrodes 131 and 132 may include an electrode layer disposed on the body 110 and a plating layer formed on the electrode layer.

For a more specific example of the electrode layer, the electrode layer may be a sintered electrode including a conductive metal and glass, or a resin-based electrode including a conductive metal and a resin.

Additionally, the electrode layer may be in the form of a sintered electrode and a resin-based electrode sequentially formed on the body. Additionally, the electrode layer may be formed by transferring a sheet including a conductive metal onto the body, or may be formed by transferring a sheet including the conductive metal onto the sintered electrode. Additionally, the electrode layer may be formed as a plating layer, or may be a layer formed using a deposition method such as a sputtering method or atomic layer deposition (ALD).

As the conductive metal included in the electrode layer, any material with excellent electrical conductivity may be used and is not particularly limited. For example, the conductive metal may be one or more of nickel (Ni), copper (Cu), and alloys thereof.

A plating layer serves to improve mounting characteristics. The type of the plating layer is not particularly limited, and may be a plating layer including one or more of Ni, Sn, Pd, and alloys thereof, and may be formed of multiple layers.

For a more specific example of the plating layer, the plating layer may be a Ni plating layer or a Sn plating layer, and may be in the form in which a Ni plating layer and a Sn plating layer are formed sequentially on the electrode layer, and may be in the form in which a Sn plating layer, a Ni plating layer, and a Sn plating layer are formed sequentially. Additionally, the plating layer may include a plurality of Ni plating layers and/or a plurality of Sn plating layers. Additionally, the plating layer may be in the form in which a Ni plating layer and a Pd plating layer are sequentially formed on the electrode layer.

A size of the multilayer electronic component 100 does not need to be particularly limited. According to the present disclosure, the multilayer electronic component 100 may be advantageous for miniaturization and high capacitance and may thus be applied to small IT products, and the multilayer electronic component 100 may secure high reliability in a variety of environments and may thus be applied to the size of automotive electronic products requiring high reliability.

According to an example embodiment of the present disclosure, the body 110 may include margin patterns 123 and 124.

The margin patterns 123 and 124 may be disposed on the dielectric layer 111 in which the internal electrodes 121 and 122 are not disposed, and may serve to alleviate a step portion between the capacitance formation portion and the margin portion.

Specifically, referring to FIGS. 2A to 2D and FIGS. 3 to 6, the margin patterns 123 and 124 may be disposed in positions different from the first internal electrode 121 and the second internal electrode 122 in the first direction, and may be disposed so as not to overlap the first internal electrode 121 or the second internal electrode 122 in the first direction. The meaning that the margin patterns 123 and 124 are disposed in positions different from the first internal electrode 121 and the second internal electrode 122 in the first direction denotes that a first directional position of the margin pattern is different from first directional positions of the first and second internal electrodes 121 and 122. The first directional position of the margin patterns 123 and 124 may be between the first directional position of the first internal electrode 121 and the first directional position of the second internal electrode 122.

Accordingly, as the first margin pattern 123 is disposed in a region in which the first internal electrode 121 is not formed, and the second margin pattern 124 is disposed in a region in which the second internal electrode 122 is not formed, a step portion caused by a difference in a stacking degree of the internal electrodes may be effectively alleviated, thereby reducing a phenomenon of reducing electrostatic capacitance by deformation of the internal electrodes 121 and 122 and the dielectric layer 111.

Additionally, because the margin patterns 123 and 124 are disposed in positions different from the first and second internal electrodes 121 and 122 in the first direction, the phenomenon in which electrical field is concentrated in ends of the first and second internal electrodes 121 and 122 may be reduced, thereby reducing a phenomenon of insulation breakdown under high voltage.

Accordingly, in the multilayer electronic component according to an example embodiment of the present disclosure, the margin patterns 123 and 124 may be disposed in positions different from the first and second internal electrodes 121 and 122 in the first direction and may be disposed so as not to overlap the first internal electrode 121 or the second internal electrode 122 in the first direction, thereby improving electrostatic capacitance and high temperature load lifespan.

Meanwhile, the margin patterns 123 and 124 may include, preferably, metal components that are difficult to diffuse into the dielectric layer 111 so as to improve an effect of compensating for the step portion, and may include, preferably, a conductive metal so as to suppress a phenomenon in which the electrical field is concentrated in the ends of the internal electrodes 121 and 122. Specifically, the margin patterns 123 and 124 may include the conductive metal, like the internal electrodes 121 and 122.

However, the conductive metal included in the margin patterns 123 and 124 is not necessarily the same as the conductive metal included in the internal electrodes 121 and 122, and when the conductive metal included in the margin patterns 123 and 124 is the same as the conductive metal included in the internal electrodes 121 and 122, the effect of alleviating the step portion according to the present disclosure may be further improved.

Referring to FIGS. 2A to 2D, the margin patterns 123 and 124 according to an example embodiment may include a first margin pattern 123 disposed so as not to overlap the first internal electrode 121 in the first direction, and a second margin pattern 124 disposed so as not to overlap the second internal electrode 122 in the first direction. Accordingly, the margin patterns 123 and 124 may be formed on a margin of the first internal electrode 121 and a margin of the second internal electrode 122, respectively, thereby further improving a step reduction effect.

In an example embodiment, at least a portion of the first margin pattern 123 may be disposed to overlap with at least a portion of a region in which the first internal electrode 121 is spaced apart from the fourth surface 4, in the first direction, and at least a portion of the second margin pattern 124 may be disposed to overlap at least a portion of a region in which the second internal electrode 122 is spaced apart from the third surface 3, in the first direction. Accordingly, the phenomenon in which the electrical field is concentrated in the ends of the first and second internal electrodes 121 and 122 may be more effectively reduced.

Referring to FIGS. 2A to 2D, the first margin pattern 123 and the second margin pattern 124 may be spaced apart from the third to fifth surfaces 3, 4, 5 and 6. Accordingly, the first margin pattern 123 and the second margin pattern 124 may be disposed not to be connected to the external electrodes 131 and 132, and may more effectively reduce the phenomenon in which the electrical field is concentrated in the ends of the first and second internal electrodes 121 and 122 while alleviating the step portion.

When the first margin pattern 123 and the second margin pattern 124 are connected to the first and second external electrodes 131 and 132, respectively, a separation distance between the first margin pattern 123 and the second external electrode 132 and a separation distance between the second margin pattern 124 and the first external electrode 131 may be short, and thus, there may be a concern of shorts. Additionally, the first margin pattern 123 and the second margin pattern 124 may affect the capacitance and withstand voltage characteristics of the multilayer electronic component 100, and the first and second margin patterns 123 and 124 may be more prone to bending and reduced connectivity as compared to the first and second internal electrodes 121 and 122, making it difficult to implement effective capacitance and withstand voltage. Additionally, it may be difficult to reduce the phenomenon in which the electrical field is concentrated in the ends of the first and second internal electrodes 121 and 122.

The margin patterns 123 and 124 may be disposed so as not to overlap the internal electrodes 121 and 122 included in the capacitance formation portion Ac, but may be disposed sufficiently adjacently to the first and second internal electrodes 121 and 122 to prevent bending of the internal electrode and deterioration of connectivity thereof in the margin portion.

Specifically, when viewed in the first direction, a separation distance between the first internal electrode 121 and the first margin pattern 123 may be 30 μm or less, and a separation distance between the second internal electrode 122 and the second margin pattern 124 may be 30 μm or less. Accordingly, bending of the internal electrode and deterioration of connectivity thereof due to the step portion may be effectively suppressed.

Meanwhile, a lower limit value of a separation distance between the first internal electrode 121 and the first margin pattern 123 and a lower limit value of a separation distance between the second internal electrode 122 and the second margin pattern 124 need to be particularly limited, but may be determined in consideration of a printing resolution of the internal electrodes 121 and 122 and the margin patterns 123 and 124.

Specifically, when viewed in the first direction, the separation distance between the first internal electrode 121 and the first margin pattern 123 may be 0.5 μm or more and 30 μm or less, and the separation distance between the second internal electrode 122 and the second margin pattern 124 may be 0.5 μm or more and 30 μm or less.

The separation distance between the first internal electrode 121 and the first margin pattern 123 and the separation distance between the second internal electrode 122 and the second margin pattern 124 may denote a separation distance between the internal electrodes 121 and 122 and the margin patterns 123 and 124 in the second direction in the first and second directional cross sections of the multilayer electronic component, and in this case, the separation distance between the internal electrodes 121 and 122 and the margin patterns 123 and 124 in the second direction in the first and second direction cross sections may be generalized by measuring values obtained by measuring and averaging distances by which five internal electrode layers disposed upwardly and five internal electrode layers disposed downwardly with respect to a first directional center in the first and second directional cross-sections polished up to a third directional center of the multilayer electronic component are spaced apart from margin patterns corresponding thereto.

Additionally, the separation distance between the first internal electrode 121 and the first margin pattern 123 and the separation distance between the second internal electrode 122 and the second margin pattern 124 may denote the separation distances between the internal electrodes 121 and 122 and the margin patterns 123 and 124 in the third direction in the first and third directional cross-sections of the multilayer electronic component. In this case, the separation distance between the internal electrodes 121 and 122 and the margin patterns 123 and 124 in the third direction in the first and third direction cross sections may be generalized by measuring values obtained by measuring and averaging distances by which, in third directional cross-sections of the internal electrodes 121 and 122 and the margin patterns 123 and 124 in the first and third directional cross-sections polished up to a second directional center of the multilayer electronic component, five internal electrode layers disposed upwardly and five internal electrode layers disposed downwardly with respect to the first directional center are spaced apart from margin patterns corresponding thereto in the third direction.

Meanwhile, preferably, the first margin pattern 123 and the second margin pattern 124 may be sufficiently spaced apart from the third to sixth surfaces 3, 4, 5 and 6 of the body 110 so as to prevent connection with the external electrodes 131 and 132 and to prevent deterioration of moisture resistance reliability. Specifically, in an example embodiment, the first margin pattern 123 and the second margin pattern 124 may be spaced apart from the third to sixth surfaces 3, 4, 5 and 6 by 15 μm or more. More preferably, the first margin pattern 123 and the second margin pattern 124 may be spaced apart from the third to sixth surfaces 3, 4, 5 and 6 by 15 μm or more and 150 μm or less.

First directional positions of the first margin pattern 123 and the second margin pattern 124 may be determined in relation to first directional positions of the first internal electrode 121 and the second internal electrode 122. Specifically, in an example embodiment, the first directional position of the first margin pattern 123 may be between the first directional position of the first internal electrode 121 and the first directional position of the second internal electrode 122, and the first directional position of the second margin pattern 124 may be between the first directional position of the second internal electrode 122 and the first directional position of the first internal electrode 121.

In an example embodiment, the first margin pattern 123 may have a shape surrounding the first internal electrode 121 and the second margin pattern 124 may have a shape surrounding the second internal electrode 122. When viewed from the first direction as illustrated in FIGS. 2A to 2D, the shape may denote a shape in which the first margin pattern 123 is disposed to surround a surface of the first internal electrode 121 facing a fourth surface 4, a surface thereof facing the fifth surface 5, and a surface thereof facing the sixth surface 6, and the second margin pattern 124 is disposed to surround a surface of the second internal electrode facing the third surface 3, a surface thereof facing the fifth surface 5, and a surface thereof facing the sixth surface 6.

A width and a length of the margin patterns 123 and 124 may be adjusted in relation to a length of a length margin and a width of a width margin. Specifically, when the margin patterns 123 and 124 account for an excessive proportion of the width margin and the length margin, the margin patterns 123 and 124 may be exposed to the third to sixth surfaces 3, 4, 5 and 6 of the body 110, and then the proportion occupied by the width margin and the length margin is insufficient, an effect of alleviating the step portion may be decreased. Accordingly, according to an example embodiment, when the width and the length of the margin pattern are appropriately adjusted in a relationship between the width of the width margin and the length of the length margin, exposure of the margin patterns 123 and 124 to the outside of the body 110 may be prevented and the effect of sufficiently alleviating the step portion may be obtained.

Specifically, referring to FIGS. 2A to 2D, a region in which the first internal electrode 121 is spaced apart from the fifth surface 5 may be defined as a first-first width margin WM1, a region in which the first internal electrode 121 is spaced apart from the fourth surface 4 may be defined as a first length margin LM1, a third directional size of the first-first width margin may be defined as WM1, and a third directional size of a margin pattern overlapping with the first-first width margin may be defined as WMP1.

In this case, when WMP1/WM1 and LMP1/LM1 are less than 0.33, because the first margin pattern 123 is not sufficiently formed, the effect of alleviating the step portion may be insufficient. When WMP1/WM1 and LMP1/LM1 exceed 0.54, the first margin pattern 123 and the first internal electrode 121 may be formed to overlap each other when viewed from the first direction.

Accordingly, in an example embodiment, when a second directional size of the first length margin is referred to as LM1, and a second directional size of the margin pattern overlapping the first length margin is referred to as LMP1, WMP1/WM1 and LMP1/LM1 may satisfy 0.33 or more and 0.54 or less, so that exposure of the margin patterns 123 and 124 to the outside of the body 110 may be prevented and the effect of alleviating the step portion may be obtained.

On the other hand, when the WMP1/WM1 is 0.37 or more and 0.54 or less, and the LMP1/LM1 is 0.33 or more and 0.51 or less, the effect of preventing the margin patterns 123 and 124 from being exposed to the outside of the body 110 and the effect of alleviating the step portion may become more remarkable.

Meanwhile, referring to FIGS. 2A to 2D, a region in which the first internal electrode 121 and the fourth surface 4 are spaced apart from each other is referred to as a first length margin, a region in which the second internal electrode 122 and the third surface 3 are spaced apart from each other is referred to as a second length margin, a region in which the first internal electrode 121 and the fifth surface 5 are spaced apart from each other is referred to as a first-first width margin, a region in which the first internal electrode 121 and the sixth surface 6 are spaced apart from each other is referred to as a first-second width margin, a region in which the second internal electrode 122 and the fifth surface 5 are spaced apart from each other is referred to as a second-first width margin, and a region in which the second internal electrode 122 and the sixth surface 6 are spaced apart from each other is referred to as a second-second width margin, a second directional size of the first length margin is indicated as LM1, a second directional size of the second length margin is indicated as LM2, a third directional size of the first-first width margin is indicated as WM1, a third directional size of the first-second width margin is indicated as WM1′, a third directional size of the second-first width margin is indicated as WM2, and a third directional size of the second-second width margin is indicated as WM2′. The first width margin includes the first-first width margin and the first-second width margin, and the second width margin includes the second-first width margin and the second-second width margin.

Additionally, a second directional size of the first margin pattern 123 overlapping the first length margin is indicated as LMP1, a second directional size of the second margin pattern 124 overlapping the second length margin is indicated as LMP2, a third directional size of the first margin pattern 123 overlapping the first-first width margin is indicated as WMP1, a third directional size of the first margin pattern 123 overlapping the first-second width margin is indicated as WMP1′, a third directional size of the second margin pattern 124 overlapping the second-first width margin is indicated as WMP2, and a third directional size of the second margin pattern 124 overlapping the second-second width margin is indicated as WMP2′.

In an example embodiment, WMP1′/WM1 may satisfy 0.33 or more and 0.54 or less, and preferably 0.37 or more and 0.54 or less. Accordingly, the effect of preventing the margin patterns 123 and 124 from being exposed to the outside of the body 110 and the effect of alleviating the step portion may be improved.

In an example embodiment, WMP2/WM2 may satisfy 0.33 or more and 0.54 or less, and preferably 0.37 or more and 0.54 or less. Accordingly, the effect of preventing the margin patterns 123 and 124 from being exposed to the outside of the body 110 and the effect of alleviating the step portion may be improved.

In an example embodiment, WMP2′/WM2′ may satisfy 0.33 or more and 0.54 or less, and preferably 0.37 or more and 0.54 or less. Accordingly, the effect of preventing the margin patterns 123 and 124 from being exposed to the outside of the body 110 and the effect of alleviating the step portion may be improved.

In an example embodiment, LMP2/LM2 may satisfy 0.33 or more and 0.54 or less, and preferably 0.33 or more and 0.51 or less. Accordingly, the effect of preventing the margin patterns 123 and 124 from being exposed to the outside of the body 110 and the effect of alleviating the step portion may be improved.

Meanwhile, in this specification, for convenience of explanation, LM1, LM2, WM1, WM1, WM2, WM2′, LMP1, LPM2, WMP1, WMP1, WMP2 and WMP2 are illustrated in FIGS. 2A to 2D, which are plan views of the internal electrode and margin pattern viewed from the first direction.

The LM1, LM2, LMP1 and LPM2 may be an average value of values measured in the five internal electrode layers disposed upwardly and the five internal electrode layers disposed downwardly with respect to the first directional center in the first and second directional cross-sections polished up to the third directional center of the multilayer electronic component 100, and the margin patterns corresponding thereto.

The WM1, WM1′, WM2, WM2′, WMP1, WMP1, WMP2 and WMP2 may be an average value of values measured in the five internal electrode layers disposed upwardly and the five internal electrode layers disposed downwardly with respect to the first directional center in the first and third directional cross-sections polished up to the second directional center of the multilayer electronic component 100, and the margin patterns corresponding thereto.

Hereinafter, the internal electrodes and the margin patterns of the multilayer electronic component 100 according to various embodiments will be described in detail.

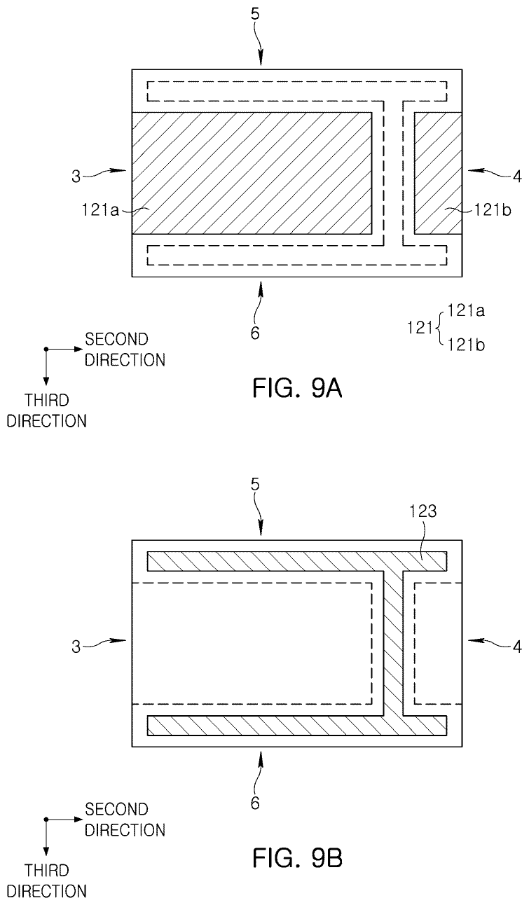

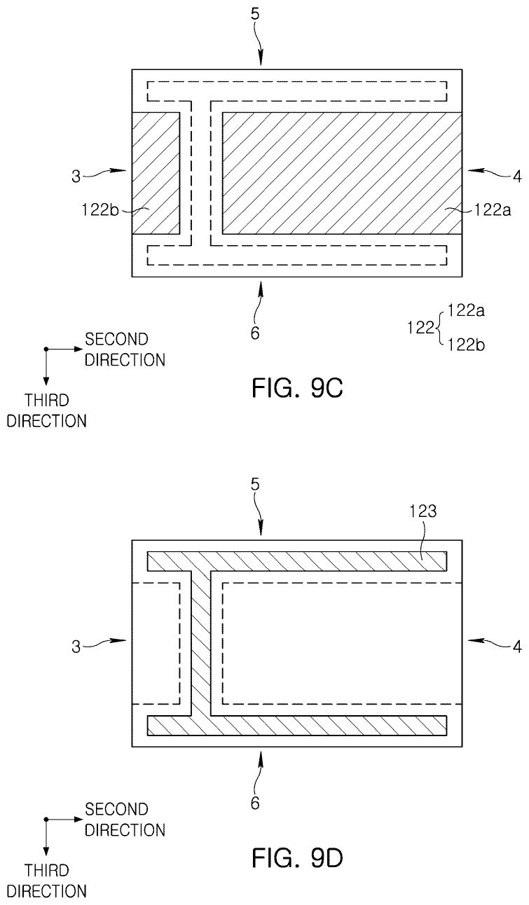

FIGS. 9A, 9B, 9C, and 9D are plan views schematically illustrating an internal electrode and a margin pattern according to an example embodiment.

Referring to 9A, 9B, 9C and 9D are plan views schematically illustrating internal electrodes and margin patterns according to an example embodiment.

Referring to FIGS. 9A, 9B, 9C and 9D, the first internal electrode 121 according to an example embodiment may include a first internal pattern 121a connected to the third surface 3 and spaced apart from the fourth, fifth and sixth sides 4, 5 and 6, and a first dummy pattern 121b spaced apart from the first internal pattern and connected to the fourth surface 4 and spaced apart from the third, fifth and sixth surfaces 3, 5 and 6, and the second internal electrode 122 may include a second internal pattern 122a connected to the fourth surface 4 and spaced apart from the third, fifth and sixth surfaces 3, 5 and 6, and a second dummy pattern 122b spaced apart from the second internal pattern and connected to the third surface 3 and spaced apart from the fourth, fifth and sixth surfaces 4, 5 and 6.

In this case, the first margin pattern 123 may be disposed to overlap a region in which the first internal electrode 121 is spaced apart from the fifth and sixth surfaces 5 and 6 and a space in which the first internal pattern 121a and the first dummy pattern 121b are spaced apart from each other, and the second margin pattern 124 may be disposed to overlap a region in which the second internal electrode 122 is spaced apart from the fifth and sixth surfaces 5 and 6 and a space in which the second internal pattern 122a and the second dummy pattern 122b are spaced apart from each other. Accordingly, even if the internal electrodes 121 and 122 have a structure including dummy patterns 121b and 122b, the step portion may be alleviated by forming a margin pattern as a whole in a region in which the internal pattern or the dummy pattern is not formed.

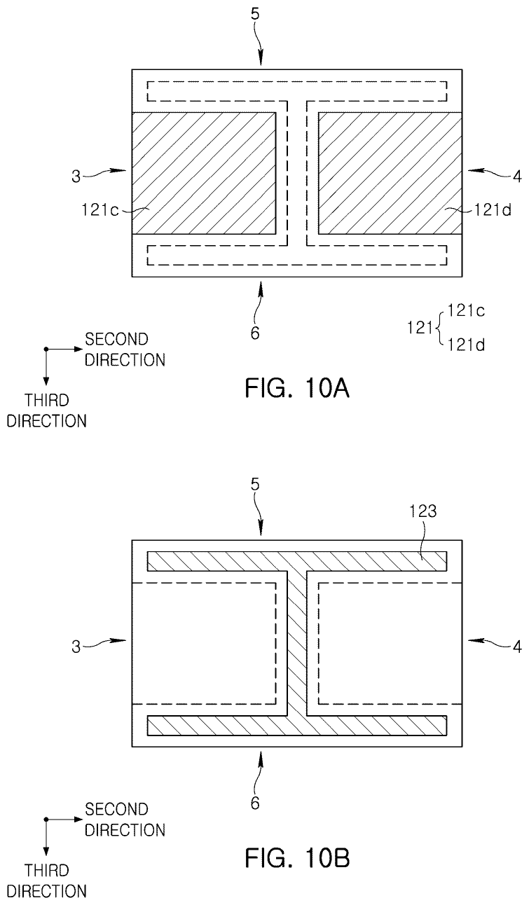

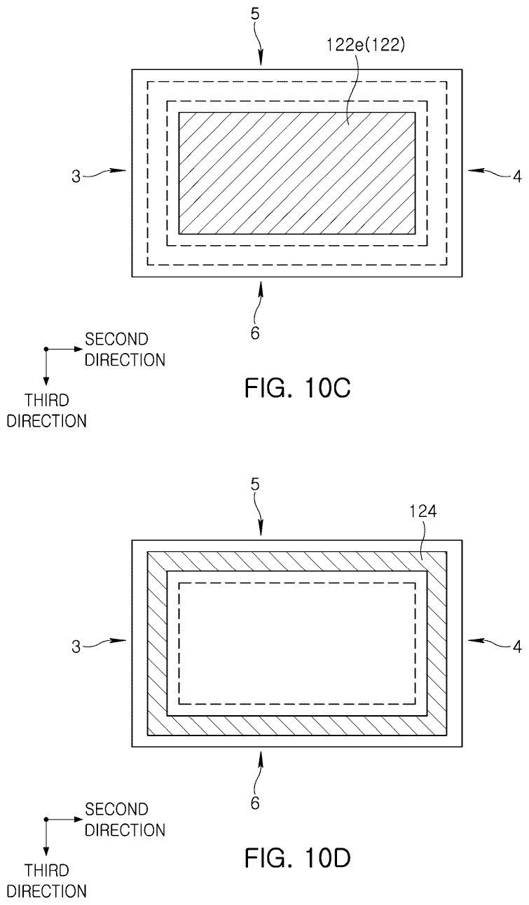

FIGS. 10A, 10B, 10C and 10D are plan views schematically illustrating an internal electrode and a margin pattern according to an example embodiment.

Referring to FIGS. 10A, 10B, 10C and 10D, the first internal electrode 121 according to an example embodiment may include a first-first internal pattern 121c connected to the third surface 3 and spaced apart from the fourth, fifth and sixth surfaces 4, 5 and 6, and a first-second internal pattern 121d spaced apart from the first internal pattern and connected to the fourth surface 4 and spaced apart from the third, fifth and sixth surfaces 3, 5 and 6, and the second internal electrode 122 may include a floating pattern 122e spaced apart from the third to sixth surfaces 3, 4, 5 and 6.

In this case, the first dummy pattern 123 may be disposed to overlap a region in which the first internal electrode 121 is spaced apart from the fifth and sixth surfaces 5 and 6 and a space in which the first-first internal pattern 121c and the first-second internal pattern 121d are spaced apart from each other, and the second dummy pattern 124 may be disposed to overlap a space in which the second internal electrode 122 is spaced apart from the third to sixth surfaces 3 to 6. Accordingly, even if the internal electrode 122 has a structure including the floating pattern 122e, the step portion may be alleviated by forming a margin pattern as a whole in a region in which the internal pattern or the floating pattern is not formed.

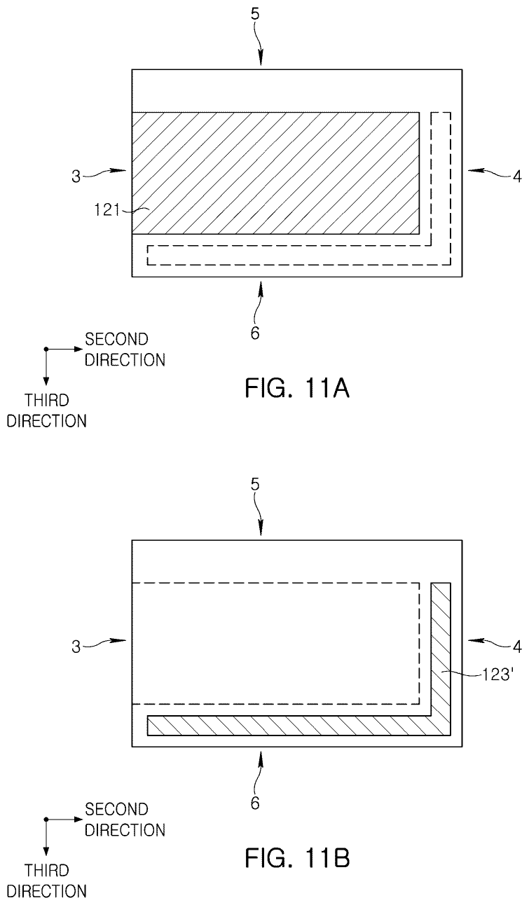

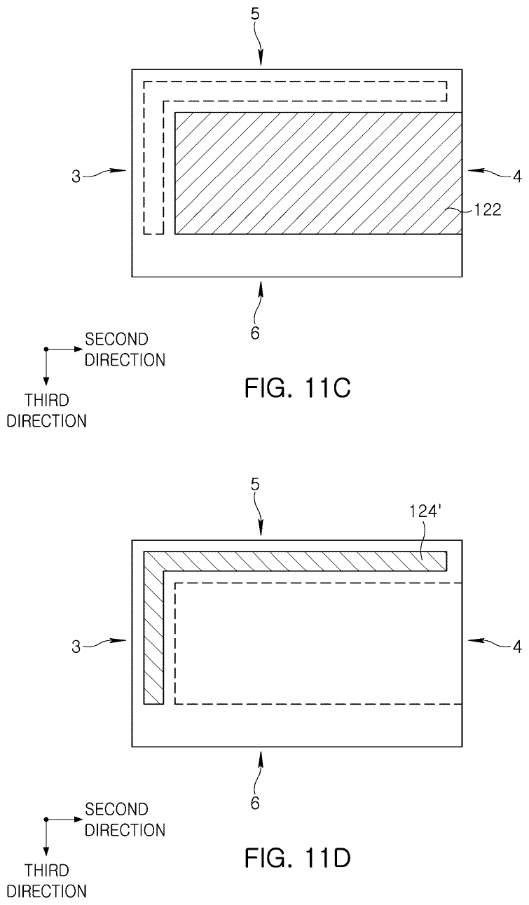

FIGS. 11A, 11B, 11C and 11D are plan views schematically illustrating an internal electrode and a margin pattern according to an example embodiment.

Referring to FIGS. 11A, 11B, 11C and 11D, when a region in which the first internal electrode 121 is spaced apart from the fifth surface 5 is referred to a first-first width margin, and a region spaced apart from the sixth surface 6 is referred to as a first-second width margin, and a region in which the first internal electrode 121 is spaced apart from the fourth surface 4 is referred to as a first length margin, a first margin pattern 123 may be disposed to overlap one of the first-first and first-second width margins and the first length margin in the first direction.

Similarly, when a region in which the second internal electrode 122 is spaced apart from the fifth surface 5 is referred to as a second-first width margin, a region spaced apart from the sixth surface 6 is referred to as the second-second width margin, and a region in which the second internal electrode 122 is spaced apart from the third surface 3 is referred to as a second length margin, a second margin pattern 124′ may be disposed to overlap one of the second-first and second-second width margins and the second length margin in the first direction.

In this case, when the first margin pattern 123′ is disposed to overlap the first-second width margin in the first direction, the second margin pattern 124′ may be disposed to overlap the second-first width margin in the first direction, and when the first margin pattern 123′ is disposed to overlap the first-first width margin in the first direction, the second margin pattern 124′ may be disposed to overlap the second-second width margin in the first direction. Accordingly, in the width margin, the first margin pattern 123′ and the second margin pattern 124′ may be prevented from overlapping each other in the first direction, thereby alleviating a step portion caused by overlapping formation of the margin patterns 123′ and 124′ in the first direction.

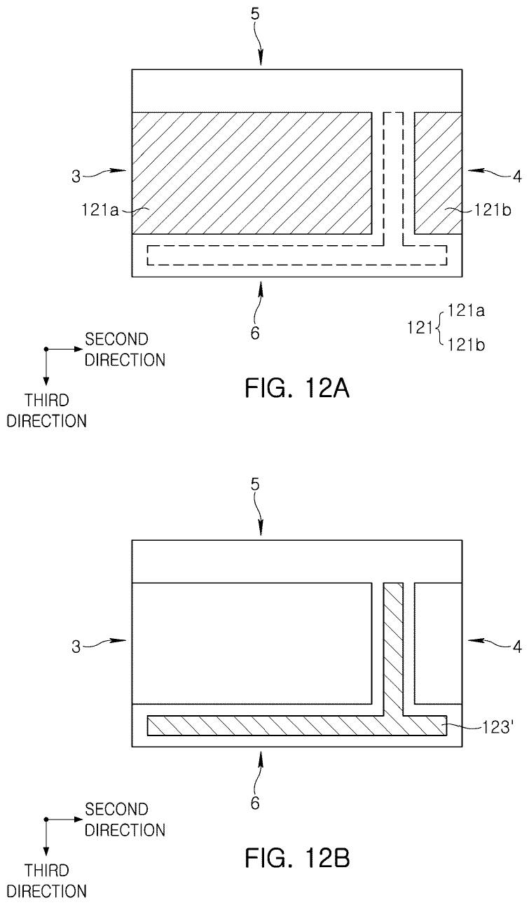

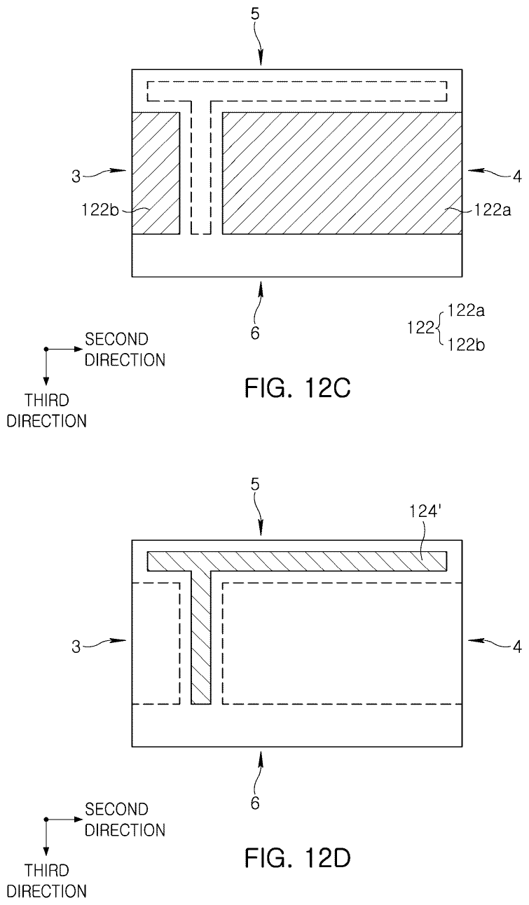

FIGS. 12A, 12B, 12C and 12D are plan views schematically illustrating an internal electrode and a margin pattern according to an example embodiment.

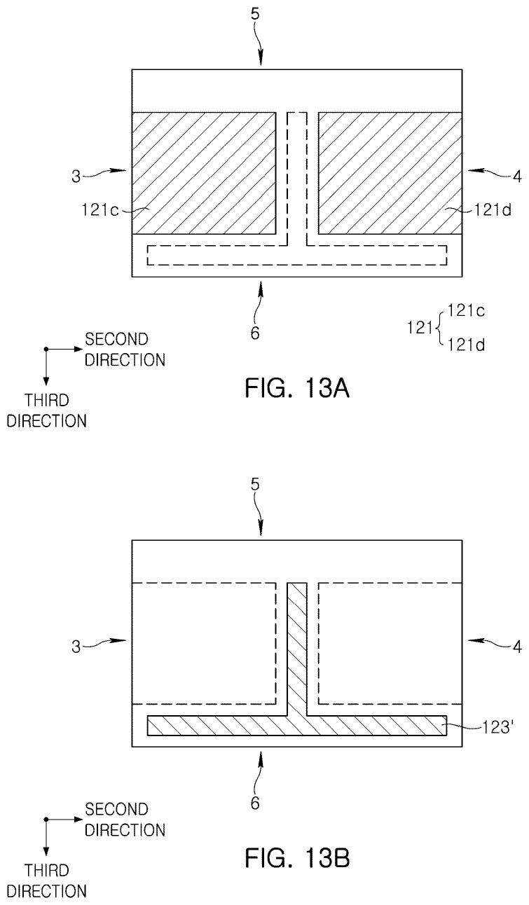

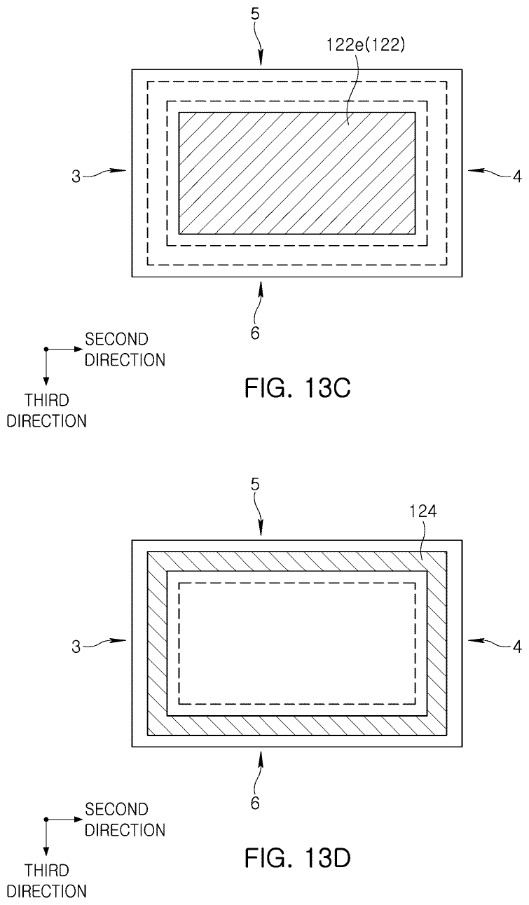

FIGS. 13A, 13B, 13C and 13D are plan views schematically illustrating an internal electrode and a margin pattern according to an example embodiment.

A structure in which the first margin pattern 123′ may be disposed to overlap one of the first-first and first-second width margins and the first length margin in the first direction, and the second margin pattern 124′ is disposed to overlap one of the second-first and second-second width margins and the second length margin in the first direction may also be applied even when the internal electrodes 121 and 122 have the dummy patterns 121b and 122b or the floating patterns 122e.

Referring to FIGS. 12A, 12B, 12C and 12D, the first internal electrode 121 according to an example embodiment may include a first internal pattern 121a connected to the third surface 3 and spaced apart from the fourth, fifth and sixth sides 4, 5 and 6, and a first dummy pattern 121b spaced apart from the first internal pattern and connected to the fourth surface 4 and spaced apart from the third, fifth and sixth surfaces 3, 5 and 6, and the second internal electrode 122 may include a second internal pattern 122a connected to the fourth surface 4 and spaced apart from the third, fifth and sixth surfaces 3, 5 and 6, and a second dummy pattern 122b spaced apart from the second internal pattern and connected to the third surface 3 and spaced apart from the fourth, fifth and sixth surfaces 4, 5 and 6.

In this case, the first margin pattern 123′ according to an example embodiment may be disposed to overlap, in the first direction, one of the first-first width margin and the first-second width margin of the first internal electrode 121 and a region in which the first internal pattern 121a and the first dummy pattern 121b are spaced apart from each other, and the second margin pattern 124 may be disposed to overlap one of the second-first width margin and the second-second width margin and a region in which the second internal pattern 122a and the second dummy pattern 122b are spaced apart from each other.

Referring to FIGS. 13A, 13B, 13C and 13D, the first internal electrode 121 according to an example embodiment may include a first-first internal pattern 121c connected to the third surface 3 and spaced apart from the fourth, fifth and sixth surfaces 4, 5 and 6, and a first-second internal pattern 121d spaced apart from the first internal pattern 121c and connected to the fourth surface 4 and spaced apart from the third, fifth and sixth surfaces 3, 5 and 6, and the second internal electrode 122 may include a floating pattern 122e spaced apart from the third to sixth surfaces 3, 4, 5 and 6.

In this case, the first margin pattern 123′ according to an example embodiment may be disposed to overlap, in the first direction, one of the first-first width margin and the first-second width margin of the first internal electrode 121 and a region in which the first-first internal pattern 121c and the first-second internal pattern 121d are spaced apart from each other.

Additionally, in FIG. 13B, the first margin pattern 123 is expressed as having a structure overlapping the first-first width margin of the first internal electrode 121 in the first direction, and a first margin pattern 123′ of the first internal electrode 121 disposed on another layer may have a structure overlapping the first-second width margin of the first internal electrode 122 in the first direction. Meanwhile, in an example embodiment, because the second internal electrode 122 includes a floating pattern 122e, the second margin pattern 124 may be disposed to overlap, in the first direction, at least one of a region in which the second internal electrode 122 is spaced apart from the third surface 3, a region in which the second internal electrode 122 is spaced apart from the fourth surface 4, a region in which the second internal electrode 122 is spaced apart from the fifth surface 5, and a region in which the second internal electrode 122 is spaced apart from the sixth surface 6.

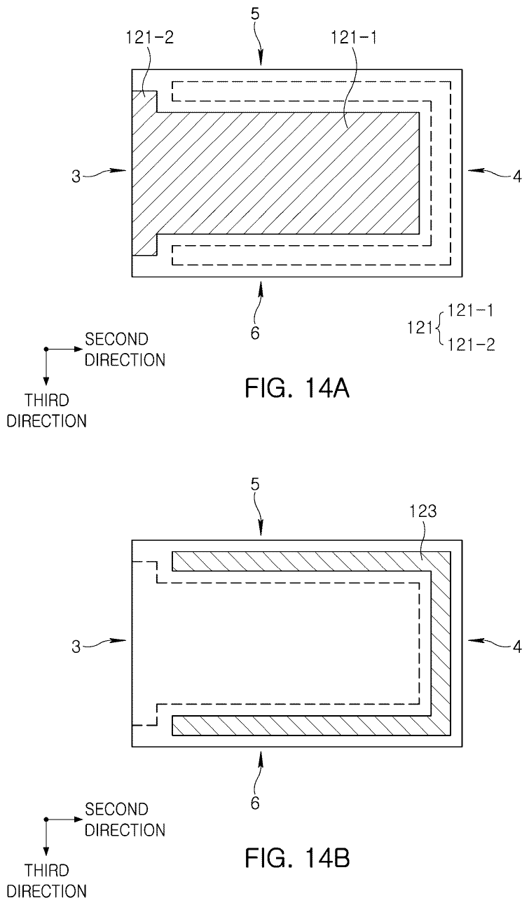

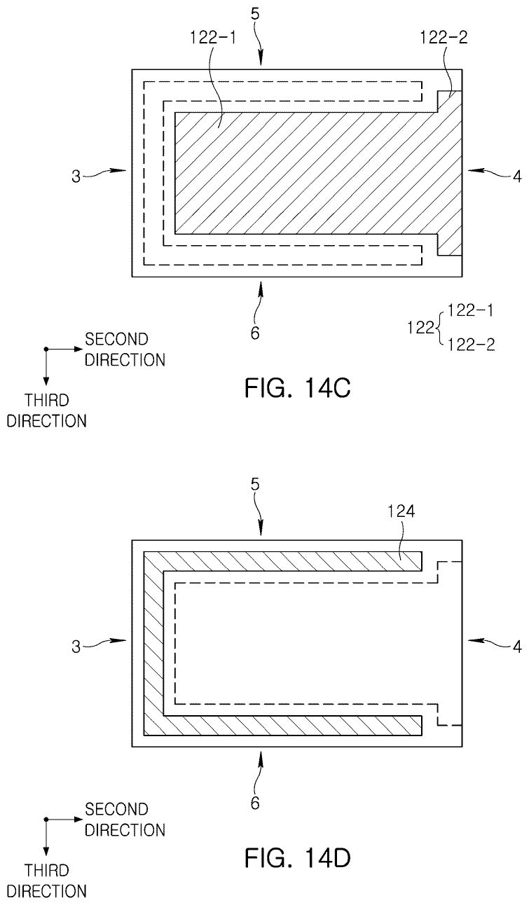

FIGS. 14A, 14B, 14C and 14D are plan views schematically illustrating an internal electrode and a margin pattern according to an example embodiment.

Referring to FIGS. 14A, 14B, 14C and 14D, in an example embodiment, the internal electrodes 121 and 122 may include main portions 121-1 and 122-1 which are regions in which the first and second internal electrodes 121 and 122 overlap each other in the first direction to form a capacitance, and lead portions 121-2 and 122-2 that are larger in size in the third direction than the main portions and extend from the main portions to the third surface 3 or the fourth surface 4.

Accordingly, a step portion occurring because the margin patterns 123 and 124 are not formed in a region spaced apart from the third surface 3 or the fourth surface 4 may be alleviated by arranging the lead portions 121-2 and 122-2 larger in size in the third direction than the main portions 121-1 and 122-1.

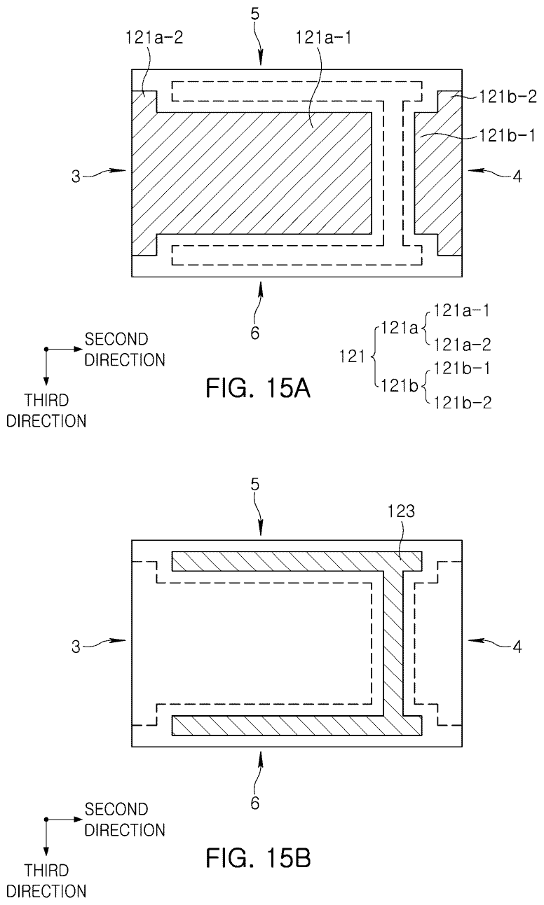

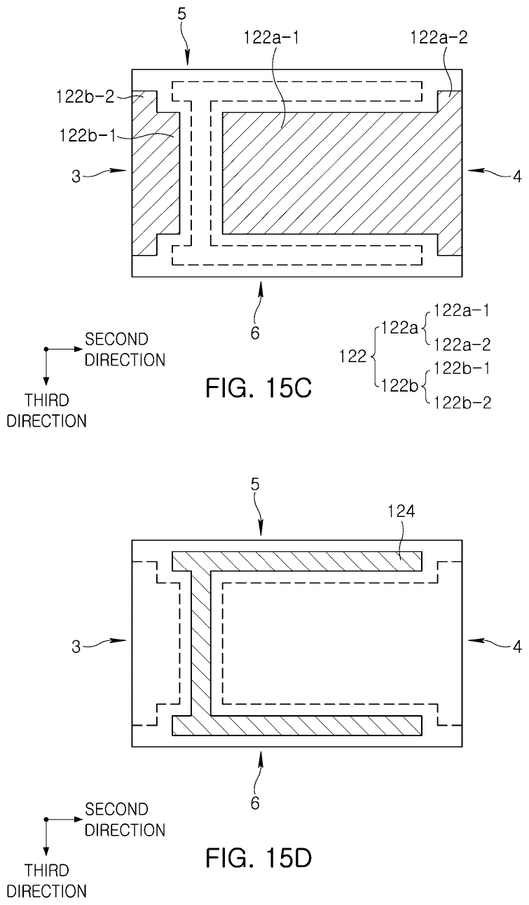

FIGS. 15A, 15B, 15C and 15D are plan views schematically illustrating an internal electrode and a margin pattern according to an example embodiment.

Referring to FIGS. 15A, 15B, 15C and 15D, the first internal electrode 121 according to an example embodiment may include a first internal pattern 121a connected to the third surface 3 and spaced apart from the fourth, fifth, and sixth surfaces 4, 5 and 6, and a first dummy pattern 121b spaced apart from the first internal pattern and connected to the fourth surface 4 and spaced apart from the third, fifth, and sixth surfaces 3, 5 and 6, and the second internal electrode 122 may include a second internal pattern 122a connected to the fourth surface 4 and spaced apart from the third, fifth and sixth surfaces 3, 5 and 6, and a second dummy pattern 122b spaced apart from the second internal pattern and connected to the third surface 3 and spaced apart from the fourth, fifth and sixth surfaces 4, 5 and 6.

The first internal pattern 121a may include a main portion 121a-1 which is a region in which the first internal pattern and the second internal pattern overlap each other in the first direction, and a lead portion 121a-2 that is larger in size in the third direction than the main portion 121a-1 and extends from the main portion 121a-1 to the third surface 3, and the first dummy pattern 121b may include a main portion 121b-1, and a lead portion 121b-2 that is larger in size in the third direction than the main portion 121b-1 and extends from the main portion 121b-1 to the fourth surface 4.

Similarly, the second internal pattern 121b may include a main portion 122a-1 which is a region in which the first internal pattern and the second internal pattern overlap each other in the first direction, and a lead portion 122a-2 that is larger in size in the third direction than the main portion 122a-1 and extends from the main portion 122a-1 to the fourth surface 4, and the second dummy pattern 122b may include a main portion 122b-1, and a lead portion 122b-2 connected to the main portion 122b-1 that is larger in size in the third direction than the main portion 122b-1 and extends from the main portion 122b-1 to the third surface 3.

In this case, in an example embodiment, the first margin pattern 123 may be disposed to overlap, in the first direction, the first-first width margin and the first-second width margin, and a region in which the first internal pattern 121a and the first dummy pattern 121b are spaced apart from each other, and the second margin pattern 124 may be disposed to overlap, in the first direction, the second-first width margin and the second-second width margin, and a region in which the second internal pattern 122a and the second dummy pattern 122b are spaced apart from each other.

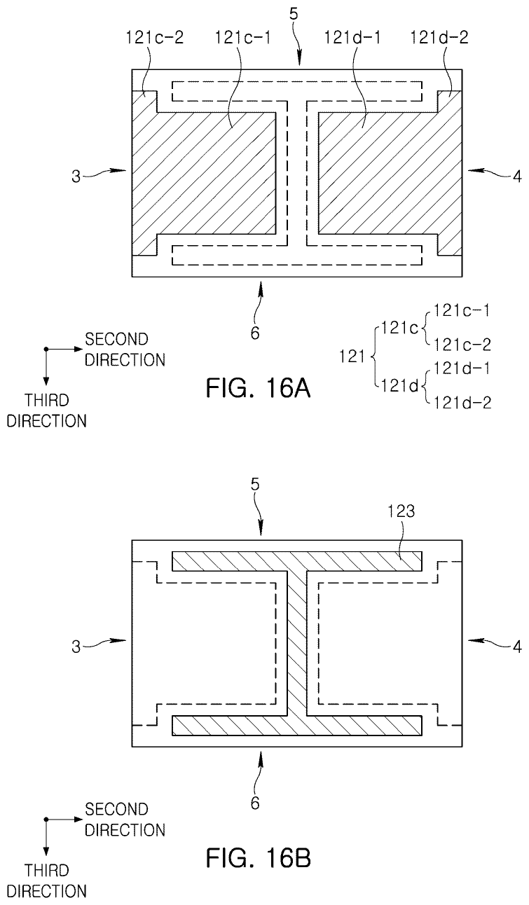

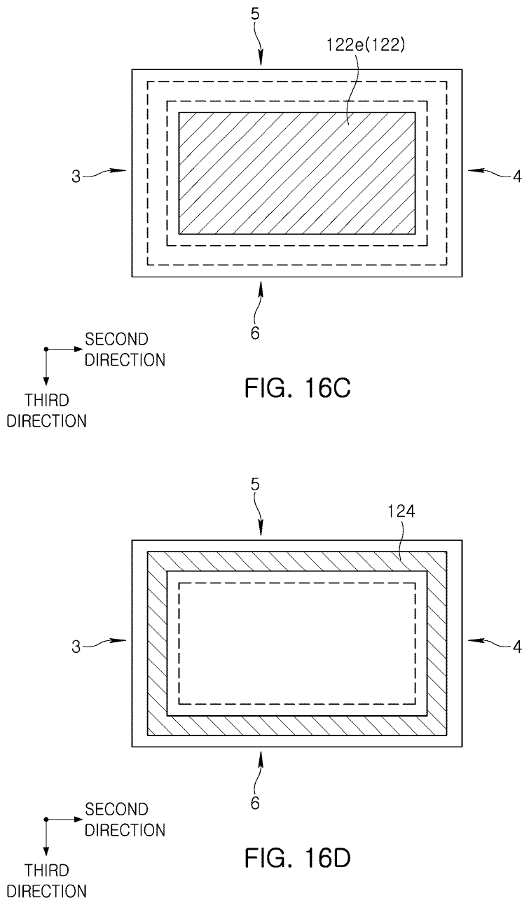

FIGS. 16A, 16B, 16C and 16D are plan views schematically illustrating an internal electrode and a margin pattern according to an example embodiment.

The first internal electrode 121 according to an example embodiment may include a first-first internal pattern 121c connected to the third surface 3 and spaced apart from the fourth, fifth and sixth surfaces 4, 5 and 6, and a first-second internal pattern 121d spaced apart from the first internal pattern and connected to the fourth surface 4 and spaced apart from the third, fifth and sixth surfaces 3, 5 and 6, and the second internal electrode 122 may include a floating pattern 122e spaced apart from the third to sixth surfaces 3, 4, 5 and 6.

The first-first internal pattern 121c may include a main portion 121c-1, and a lead portion 121c-2 that is larger in size in the third direction than the main portion 121c-1 and extends from the main portion 121c-1 to the third surface 3, and the first-second internal pattern 121d may include a main portion 121d-1, and a lead portion 121d-2 that is larger in size in the third direction than the main portion 121d-1 and extends from the main portion 121d-1 to the fourth surface 4.

In this case, the first margin pattern 123 according to an example embodiment may be disposed to overlap, in the first direction, the first-first width margin and the first-second width margin of the first internal electrode 121, and a region in which the first internal pattern 121c and the second internal pattern 121d are spaced apart from each other.

In this case, the second margin pattern 124 may be disposed to overlap, in the first direction, at least one of a region in which the second internal electrode 122 is spaced apart from the third surface 3, a region in which the second internal electrode 122 is spaced apart from the fourth surface 4, a region in which the second internal electrode 122 is spaced apart from the fifth surface 5, and a region in which the second internal electrode 122 is spaced apart from the sixth surface 6.

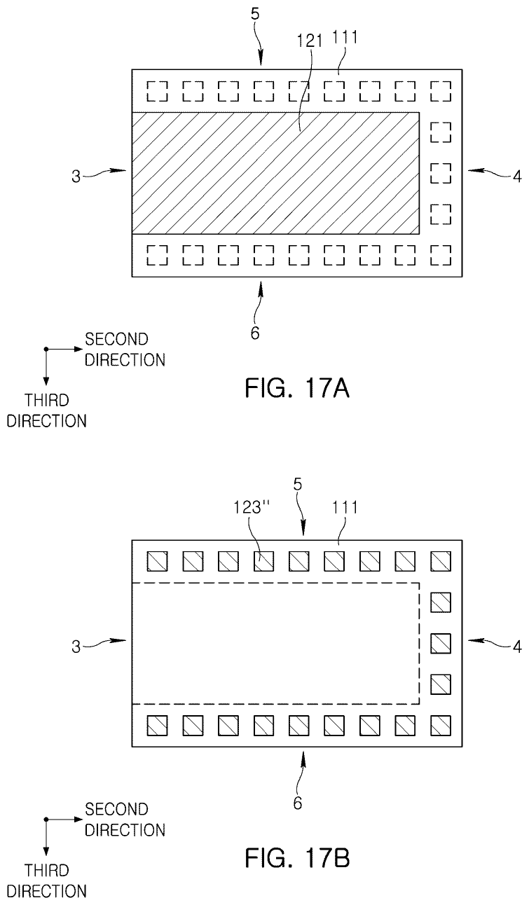

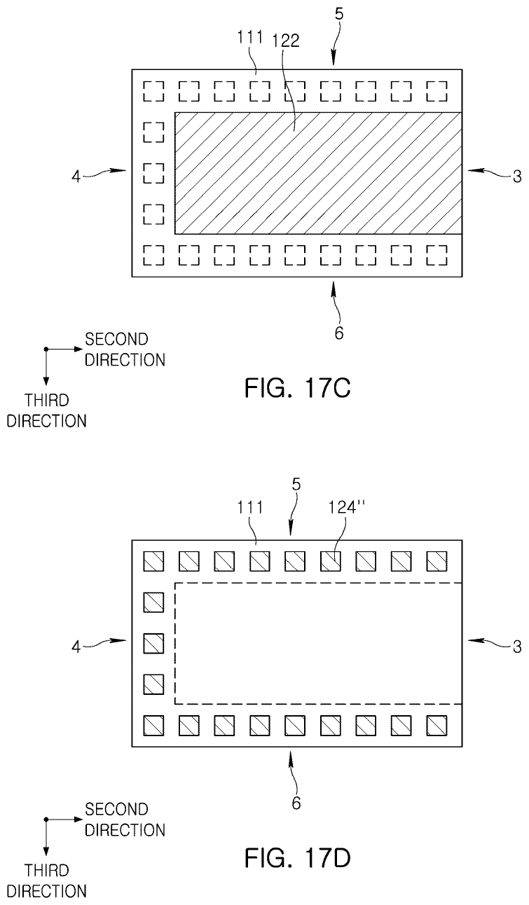

FIGS. 17A, 17B, 17C and 17D are plan views schematically illustrating an internal electrode and a margin pattern according to an example embodiment.

Referring to FIGS. 17A, 17B, 17C and 17D, margin patterns 123″ and 124″ according to an example embodiment may be comprised of a plurality of spaced apart patterns. Accordingly, the margin patterns 123″ and 124″ may be formed in at least one of a length margin and a width margin of the internal electrodes 121 and 122, which may alleviate a step portion and simultaneously improve adhesive force between the dielectric layers 111, so that electrostatic capacitance and high-temperature load lifespan of the multilayer electronic component 100 may be improved while the strength of the component itself may be improved.

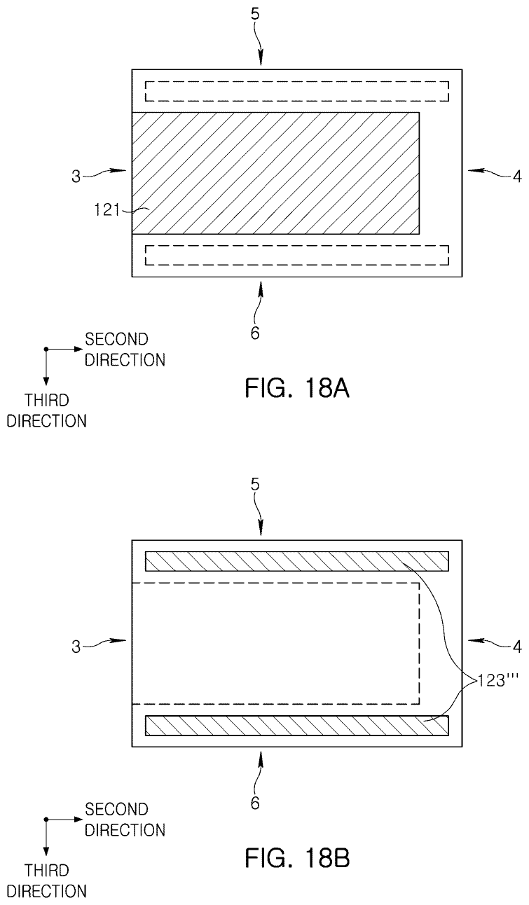

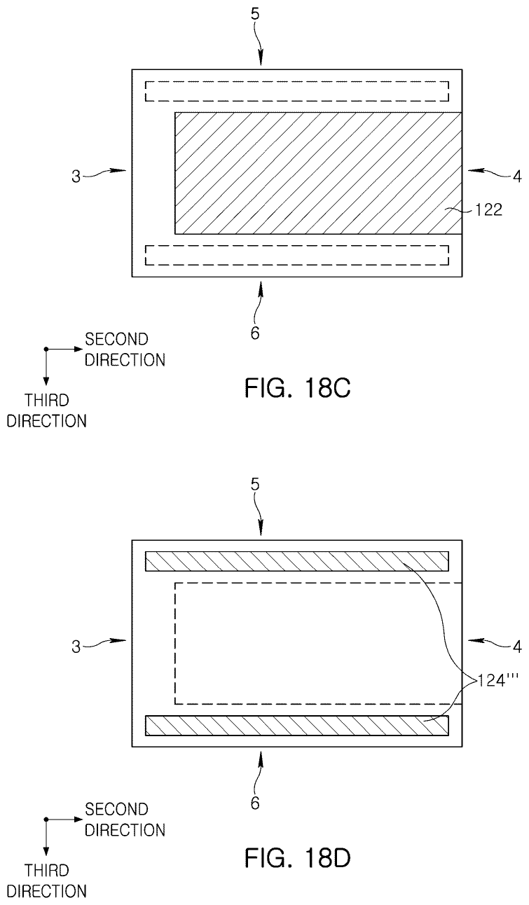

FIGS. 18A, 18B, 18C and 18D are plan views schematically illustrating an internal electrode and a margin pattern according to an example embodiment.

Referring to FIGS. 18A, 18B, 18C and 18D, the margin patterns 123′″ and 124′″ according to an example embodiment may not be disposed to overlap the length margin, but may be disposed to overlap only the width margin. That is, when a region in which the first internal electrode 121 is spaced apart from the fifth and sixth surfaces is referred to as a first width margin, a region in which the first internal electrode 121 is spaced apart from the fourth surface is referred to as a first length margin, a region in which the second internal electrode 122 is spaced apart from the fifth and sixth surfaces is referred to as a second width margin, and a region in which the second internal electrode 122 is spaced apart from the third surface is referred to as a second length margin, the first and second margin patterns 123′″ and 124′″ may be disposed to overlap the first and second width margins, and may be disposed so as not to overlap the first and second length margins. In this case, the margin patterns 123′″ and 124′″ may have a straight shape when observed from a stacking direction. Additionally, as illustrated in FIGS. 18A, 18B, 18C and 18D, the margin patterns 123′″ and 124′″ may be disposed to overlap both sides of the width margin, but the present disclosure is not limited thereto, and the margin patterns 123′″ and 124′″ may be disposed to overlap only either side of the width margin.

### Method for Manufacturing Multilayer Electronic Component

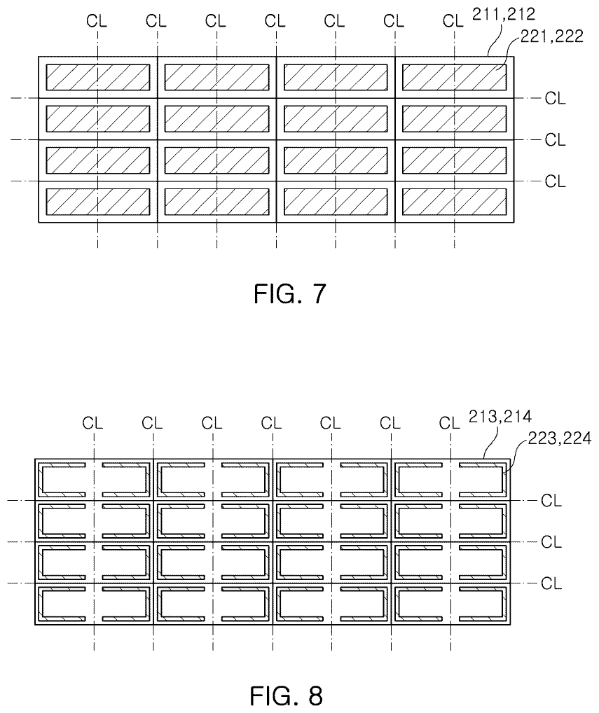

FIG. 7 is a plan view schematically illustrating a state in which an internal electrode is disposed on a ceramic sheet according to an example embodiment.

FIG. 8 is a plan view schematically illustrating a state in which a margin pattern is disposed on a ceramic sheet according to an example embodiment

Hereinafter, a method for manufacturing a multilayer electronic component according to an example embodiment of the present disclosure will be described with reference to FIGS. 7 and 8.

A method for manufacturing a multilayer electronic component according to an example embodiment of the present disclosure may include a stacking operation of obtaining a stack body in a manner in which a first sheet with a first pattern 221 disposed on a first ceramic sheet 211 and a second sheet with a second pattern 222 disposed on a second ceramic sheet 212 are alternately stacked in a first direction, a third sheet with third patterns 223 and 224 disposed on a third ceramic sheet 123 is disposed between the first sheet and the second sheet, and the third pattern is stacked so as not to overlap the first pattern or the second pattern; a sintering operation of obtaining a body 110 by sintering the stack body; and an operation of forming an external electrode on the body.

The ceramic sheets 211, 212, 213 and 214 may be divided into a first ceramic sheet 211, a second ceramic sheet 212, a third-first ceramic sheet 213, and a third-second ceramic sheet 214.

The ceramic sheets 211, 212, 213 and 214 may be formed of a ceramic paste including ceramic powder particles, an organic solvent, a dispersant, and a binder. The ceramic powder particles may include raw materials for forming a dielectric layer 111 of the multilayer electronic component 100.

Referring to FIG. 7, the first pattern 221 may be disposed on the first ceramic sheet 211 and the second pattern 222 may be disposed on the second ceramic sheet 212.

An example of a method for forming the first pattern 221 and the second pattern 222 may include screen printing or gravure printing a conductive paste including a conductive metal on the first ceramic sheet 211 and the second ceramic sheet 212, but the present disclosure is not limited thereto, and a thin film deposition method such as a sputtering method or a vacuum deposition method may be used for depositing the conductive metal on the first ceramic sheet 211 and the second ceramic sheet 212.

The first pattern 221 and the second pattern 222 may include a conductive metal. The conductive metal is not particularly limited, and any material with excellent electrical conductivity may be used. For example, the conductive metals may include one or more of nickel (Ni), copper (Cu), palladium (Pd), silver (Ag), gold (Au), platinum (Pt), tin (Sn), tungsten (W), titanium (Ti), and alloys thereof.

The first pattern 221 and the second pattern 222 may be a plurality of patterns disposed to be spaced apart from each other by an interval in a direction, perpendicular to a stacking direction.

The first pattern 221 may be sintered to form the first internal electrode 121, and the second pattern 222 may be sintered to form the second internal electrode 122.

In the stacking step according to an example embodiment of the present disclosure, the third sheet with the third patterns 223 and 224 disposed on the third ceramic sheets 213 and 214 may be disposed between the first sheet and the second sheet.

In this case, the first sheet and the second sheet may be offset and stacked by a distance between adjacent cutting lines CL in a second direction, and the third patterns 223 and 224 of the third sheet may be stacked so as not to overlap the first pattern 221 or the second pattern 222.

Referring to FIG. 8, the third patterns 223 and 224 may surround the first and second patterns 221 and 222 when viewed from the stacking direction. However, the third patterns 223 and 224 may have a shape that does not overlap the first and second patterns 221 and 222 when viewed from the stacking direction. However, each of the patterns forming the third patterns 223 and 224 may not completely surround the first and second patterns 221 and 222 when viewed from the first direction. Specifically, each unit pattern of the third patterns 223 and 224 may be disposed to be spaced apart based on a cutting line CL described below, and may be a shape that is symmetrical to each other based on the cutting line CL.

Meanwhile, the third patterns 223 and 224 may include, preferably, components that are difficult to diffuse into the ceramic sheets 211, 212, 213 and 214 in order to improve the effect of compensating for a step portion, and may include, preferably a conductive metal so as to suppress a phenomenon in which an electrical field is concentrated in the ends of the internal electrodes 121 and 122. Specifically, the third patterns 223 and 224 may include a conductive metal, like the first and second patterns 221 and 222.

However, a conductive metal included in the third patterns 223 and 224 is not necessarily the same as a conductive metal included in the first and second patterns 221 and 222, but when the conductive metal included in the third patterns 223 and 224 is the same as the conductive metal included in the first and second patterns 221 and 222, an effect of alleviating the step portion according to the present disclosure may be further improved.

Referring to FIG. 8, the third patterns 223 and 224 may be sintered and may then be disposed and stacked on a ceramic sheet (a third ceramic sheet) different from the first pattern 221 and the second pattern 222 forming the internal electrodes 121 and 122, and thus, the third patterns 223 and 224 may be sintered and then disposed in positions different from the first and second internal electrodes 121 and 122 in the first direction, thus forming margin patterns 123 and 124 so as not to overlap the first internal electrode 121 or the second internal electrode 122 in the first direction.

After the stacking operation, referring to FIGS. 7 and 8, the first to third sheets may formed into a stack body, and then, a cutting operation of cutting along the cutting line CL may be performed. The cutting line CL in FIG. 7 and the cutting line CL in FIG. 8 may be the same cutting line. The cutting line CL may be a straight line passing through the center of each pattern forming the first and second patterns 211 and 212 and a straight line crossing the center of a space in which respective patterns are spaced apart from each other, but deviations may occur depending on the process.

After the cutting operation, a sintering operation to obtain a body by sintering the stack body may be performed.

A temperature in the sintering operation is not particularly limited, but may be sintered at, for example, 1000 to 1300° C. Additionally, the sintering may be performed under a reducing atmosphere.

After the sintering operation, an operation of forming external electrodes 131 and 132 on the body 110 may be performed.

The external electrodes 131 and 132 may be formed by transferring a sheet including a conductive metal, or by a method of sequentially forming a sintered electrode and a conductive resin layer including a conductive metal and a resin on the stack body.

The third sheet may include a third-first sheet with a third-first pattern 223 disposed on a third-first ceramic sheet 213, and a third-second sheet with a third-second pattern 224 disposed on the third-second ceramic sheet 214, and the stacking operation may be an operation of stacking the third-first sheet and the third-second sheet alternately in the first direction. Accordingly, as a result of stacking the first sheet, the third-first sheet, the second sheet, and the third-second sheet in order, the third-first pattern 223 forming the first margin pattern 123 after sintering may be disposed so as not to overlap the first pattern 221 in the first direction, and the third-second pattern 224 forming the second margin pattern 124 after sintering may be disposed so as not to overlap the second pattern 222 in the first direction. That is, in an example embodiment, the third-first pattern may be disposed so as not to overlap the first pattern in the first direction, and the third-second pattern may be disposed so as not to overlap the second pattern in the first direction.

In an example embodiment, when viewed in the first direction, a separation distance between the first pattern 221 and the third-first pattern 223 may be 30 μm or less, and a separation distance between the second pattern 222 and the third-second pattern 224 may be 30 μm or less. Accordingly, after sintering, a separation distance between the first internal electrode 121 and the first margin pattern 123 may be adjusted to 30 μm or less, and a separation distance between the second internal electrode 122 and the second margin pattern 124 may be adjusted to 30 μm or less.

In an example embodiment, when viewed in the first direction, a separation distance between the first pattern 221 and the third-first pattern 223 may be 0.5 μm or more and 30 μm or less, and a separation distance between the second pattern 222 and the third-second pattern 224 may be 0.5 μm or more and 30 μm or less. Accordingly, after sintering, a separation distance between the first internal electrode 121 and the first margin pattern 123 may be adjusted to 0.5 μm or more and 30 μm or less, and a separation distance between the second internal electrode 122 and the second margin pattern 124 may be adjusted to 0.5 μm or more and 30 μm or less.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the claims, appended and these replacements, modifications, or changes should be construed as being included in the scope of the present disclosure.

In addition, the expression ‘one embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including a plurality of dielectric layers, a first internal electrode, a second internal electrode, and a margin pattern; and
an external electrode disposed on the body,
wherein the first and second internal electrodes are alternately disposed in a first direction with the dielectric layer interposed therebetween, and
the margin pattern is disposed in a position different from the first and second internal electrodes in the first direction and is disposed so as not to overlap the first internal electrode or the second internal electrode in the first direction.

2. The multilayer electronic component according to claim 1, wherein the margin pattern includes a first margin pattern disposed so as not to overlap the first internal electrode in the first direction and a second margin pattern disposed so as not to overlap the second internal electrode in the first direction, and
the first margin pattern and the second margin pattern are alternately disposed in the first direction.

3. The multilayer electronic component according to claim 2, wherein the body has first and second surfaces opposing each other in the first direction, third and fourth surfaces connected to the first and second surfaces and opposing each other in a second direction, and fifth and sixth surfaces connected to the first to fourth surfaces and opposing each other in a third direction.

4. The multilayer electronic component according to claim 3, wherein the first internal electrode is connected to the third surface and is spaced apart from the fourth, fifth and sixth surfaces,
the second internal electrode is connected to the fourth surface and is spaced apart from the third, fifth and sixth surfaces, and
the first and second margin patterns are spaced apart from the third to sixth surfaces.

5. The multilayer electronic component according to claim 4, wherein, when viewed in the first direction, a separation distance between the first internal electrode and the first margin pattern is 30 μm or less, and a separation distance between the second internal electrode and the second margin pattern is 30 μm or less.

6. The multilayer electronic component according to claim 4, wherein, when viewed in the first direction, a separation distance between the first internal electrode and the first margin pattern is 0.5 μm or more and 30 μm or less, and a separation distance between the second internal electrode and the second margin pattern is 0.5 μm or more and 30 μm or less.

7. The multilayer electronic component according to claim 3, wherein the first and second margin patterns are spaced apart from the third to sixth surfaces by a distance of 15 μm or more.

8. The multilayer electronic component according to claim 1, wherein a first directional position of the margin pattern is disposed between a first directional position of the first internal electrode and a first directional position of the second internal electrode.

9. The multilayer electronic component according to claim 4, wherein, a region in which the first internal electrode is spaced apart from the fifth surface is referred to a first-first width margin, a region in which the first internal electrode is spaced apart from the fourth surface is referred to as a first length margin, a third directional size of the first-first width margin is referred to as WM1, a third directional size of the margin pattern overlapping the first-first width margin is referred to as WMP1, a second directional size of the first length margin is referred to as LM1, and a second directional size of the margin pattern overlapping the first length margin is referred to as LMP1, and
WMP1/WM1 and LMP1/LM1 satisfy 0.33 or more and 0.54 or less.

10. The multilayer electronic component according to claim 9, wherein the WMP1/WM1 satisfies 0.37 or more and 0.54 or less, and the LMP1/LM1 satisfies 0.33 or more and 0.51 or less.

11. The multilayer electronic component according to claim 4, wherein, when viewed from the first direction, the first margin pattern has a shape surrounding the first internal electrode, and the second margin pattern has a shape surrounding the second internal electrode.

12. The multilayer electronic component according to claim 4, wherein, a region in which the first internal electrode is spaced apart from the fifth surface is referred to as a first-first width margin, a region spaced apart from the sixth surface is referred to as a first-second width margin, and a region in which the first internal electrode is spaced apart from the fourth surface is referred to as a first length margin, and
the first margin pattern is disposed to overlap one of the first-first and first-second width margins and the first length margin in the first direction.

13. The multilayer electronic component according to claim 4, wherein, a region in which the first internal electrode is spaced apart from the fifth and sixth surfaces is referred to as a first width margin, a region in which the first internal electrode is spaced apart from the fourth surface is referred to as a first length margin, a region in which the second internal electrode is spaced apart from the fifth and sixth surfaces is referred to as a second width margin, and a region in which the second internal electrode is spaced apart from the third surface is referred to as a second length margin, and
the first and second margin patterns are disposed to overlap the first and second width margins, and are disposed so as not to overlap the first and second length margins.

14. The multilayer electronic component according to claim 1, wherein the margin pattern is comprised of a plurality of spaced apart patterns.

15. The multilayer electronic component according to claim 3, wherein the first internal electrode includes a first internal pattern connected to the third surface and spaced apart from the fourth, fifth, and sixth surfaces, and a first dummy pattern spaced apart from the first internal pattern and connected to the fourth surface and spaced apart from the third, fifth and sixth surfaces, and
the second internal electrode includes a second internal pattern connected to the fourth surface and spaced apart from the third, fifth and sixth surfaces, and a second dummy pattern spaced apart from the second internal pattern and connected to the third surface.

16. The multilayer electronic component according to claim 15, wherein the first margin pattern is disposed to overlap a region in which the first internal electrode is spaced apart from the fifth and sixth surfaces and a space in which the first internal pattern and the first dummy pattern are spaced apart from each other, and
the second margin pattern is disposed to overlap a region in which the second internal electrode is spaced apart from the fifth and sixth surfaces and a space in which the second internal pattern and the second dummy pattern are spaced apart from each other.

17. The multilayer electronic component according to claim 3, wherein the first internal electrode includes a first-first internal pattern connected to the third surface and spaced apart from the fourth, fifth and sixth surfaces, and a first-second internal pattern spaced apart from the first internal pattern and connected to the fourth surface and spaced apart from the third, fifth and sixth surfaces, and
the second internal electrode e includes a floating pattern spaced apart from the third to sixth surfaces.

18. The multilayer electronic component according to claim 17, wherein the first dummy pattern is disposed to overlap a region in which the first internal electrode is spaced apart from the fifth and sixth surfaces and a space in which the first-first internal pattern and the first-second internal pattern are spaced apart from each other, and
the second dummy pattern is disposed to overlap a space in which the second internal electrode is spaced apart from the third to sixth surfaces.

19. A method for manufacturing a multilayer electronic component, the method comprising:
a stacking operation of obtaining a stack body in a manner in which a first sheet with a first pattern disposed on a first ceramic sheet and a second sheet with a second pattern disposed on a second ceramic sheet are alternately stacked in a first direction, a third sheet with a third pattern disposed on a third ceramic sheet is disposed between the first sheet and the second sheet, and the third pattern is stacked so as not to overlap the first pattern or the second pattern in the first direction;
a sintering operation of obtaining a body by sintering the stack body; and
an operation of forming an external electrode on the body.

20. The method for manufacturing a multilayer electronic component according to claim 19, wherein the third sheet includes a third-first sheet with a third-first pattern disposed on a third-first ceramic sheet, and a third-second sheet with a third-second pattern disposed on a third-second ceramic sheet, and
in the stacking operation, the third-first ceramic sheet and the third-second ceramic sheet stacked alternately in the first direction.

21. The method for manufacturing a multilayer electronic component according to claim 20, wherein the third-first pattern is disposed so as not to overlap the first pattern in the first direction, and the third-second pattern is disposed so as not to overlap the second pattern in the first direction.

22. The method for manufacturing a multilayer electronic component according to claim 21, wherein, when viewed in the first direction, a separation distance between the first pattern and the third-first pattern is 30 μm or less, and a separation distance between the second pattern and the third-second pattern is 30 μm or less.

23. The method for manufacturing a multilayer electronic component according to claim 21, wherein, when viewed in the first direction, a separation distance between the first pattern and the third-first pattern is 0.5 μm or more and 30 μm or less, and a separation distance between the second pattern and the third-second pattern is 0.5 μm or more and 30 μm or less.

24. A multilayer electronic component, comprising:
a body including a capacitance formation portion including a plurality of dielectric layers, a first internal electrode, a second internal electrode, and a margin pattern including a portion disclosed in a region outside the capacitance formation portion; and
an external electrode disposed on the body,
wherein the first and second internal electrodes are alternately disposed in a first direction with the dielectric layer interposed therebetween, and
in the first direction, the margin pattern is disposed in a position different from the first and second internal electrodes.

25. The multilayer electronic component according to claim 24, wherein the margin pattern includes a first margin pattern and a second margin pattern, and
the first internal electrode, the first margin pattern, the second internal electrode, and the second margin pattern are alternately disposed in the first direction.

26. The multilayer electronic component according to claim 25, wherein the body has first and second surfaces opposing each other in the first direction, third and fourth surfaces connected to the first and second surfaces and opposing each other in a second direction, and fifth and sixth surfaces connected to the first to fourth surfaces and opposing each other in a third direction
the first internal electrode is connected to the third surface and is spaced apart from the fourth, fifth and sixth surfaces,
the second internal electrode is connected to the fourth surface and is spaced apart from the third, fifth and sixth surfaces, and
the first and second margin patterns are spaced apart from the third to sixth surfaces.

27. The multilayer electronic component according to claim 26, wherein, when viewed in the first direction, a separation distance between the first internal electrode and the first margin pattern is 30 μm or less, and a separation distance between the second internal electrode and the second margin pattern is 30 μm or less.

28. The multilayer electronic component according to claim 26, wherein the first and second margin patterns are spaced apart from the third to sixth surfaces by a distance of 15 μm or more.

29. The multilayer electronic component according to claim 25, wherein, when viewed in the first direction, the first margin pattern extends along an edge of the first internal electrode and the second margin pattern extends along an edge of the second internal electrode.

30. The multilayer electronic component according to claim 24, wherein the margin pattern is comprised of a plurality of spaced apart patterns.

31. The multilayer electronic component according to claim 24, wherein the margin pattern and the first and second internal electrodes include a same material.
